(19) United States
(12) Patent Application Publication
(10) Pub. No.: US 2013/0217735 A1
(43) Pub. Date: Aug. 22, 2013

(54) FUNGICIDAL COMPOSITIONS AND METHODS OF USE

(71) Applicants: Robin D. Rogers, Tuscaloosa, AL (US); Louise R. Cooke, Belfast (GB)

(72) Inventors: Robin D. Rogers, Tuscaloosa, AL (US); Louise R. Cooke, Belfast (GB)

(73) Assignees: Agri-Food and BioSciences Institute, Belfast (GB); THE BOARD OF TRUSTEES OF THE UNIVERSITY OF ALABAMA, Tuscaloosa, AL (US)

(21) Appl. No.: 13/816,598

(22) PCT Filed: Aug. 12, 2011
(86) PCT No.: PCT/US11/47619

§ 371 Date: Feb. 12, 2013

Related U.S. Application Data
(60) Provisional application No. 61/373,104, filed on Aug. 12, 2010.

(51) Int. Cl. A01N 43/50; A01N 37/02; A01N 41/04; A01N 43/78; A01N 37/18

(52) U.S. Cl. CPC A01N 43/50; A01N 43/78; A01N 37/18; A01N 41/04; A01N 37/02
USPC 514/365; 514/396; 514/399

(57) ABSTRACT

Disclosed are compositions and methods of preparing compositions of active fungicidal ingredients. Also disclosed are methods of using the compositions described herein to improve fungicide penetration into the plant tissue, reduce fungicide volatility and drift, decrease water solubility of the fungicides, and introduce additional biological function to fungicides.

### CROSS REFERENCE TO RELATED APPLICATIONS

This application claims the benefit of priority to U.S. Provisional Application 61/373,104, filed Aug. 12, 2010, which is incorporated by reference herein in its entirety.

### FIELD

The subject matter disclosed herein generally relates to compositions and to methods of preparing compositions of active fungicidal ingredients. The fungicidal compositions are designed to improve the systemicity and/or fungicidal activity. Also, the subject matter disclosed herein generally relates to methods of using the compositions described herein to improve fungicide penetration into the plant tissue, reduce fungicide volatility and drift, and decrease water solubility of the fungicides.

### BACKGROUND

Fungicides are used to fight plant diseases that can cause severe adverse effects on crop yields and quality. Fungicides are extensively used for many functions, including the protection of seed grain during storage, the protection of mature crops, berries, and seedlings, and the suppression of mildew on the crops. Resistance to systemic fungicides is a major challenge for crops. There are only a few groups of systemic and semi-systemic fungicides that are approved for use on potatoes, including certain fungicides belonging to the dicarboximide, benzimidazole, and demethylation inhibitor (DMI) groups.

Among the benzimidazole fungicides, thiabendazole (TBZ) is the only compound currently approved for use against potato tuber diseases and is thus present in various products. The problems associated with this fungicide include resistance conferred due to specific mutations (e.g., single base changes) in the β-tubulin gene, which have affected its activity in controlling silver scurf, skin spot, and dry rot (as seen, for example, in some of the Fusarium species). In addition, thiabendazole exhibits limited penetration into the potato tissue as most of the fungicide stays on the skin. Currently, thiabendazole is mostly used in combinations with other fungicides, as shown, for example, in Chinese Patent Nos. CN101485312, CN101485313, and CN101406194, and International Patent Publication No. WO 2008/110274.

In the demethylation inhibitors group, imazalil is currently the only DMI approved for use on potatoes and is also present in various products. Salts of imazalil useful as fungicides and bactericides have been described in Wojciechowski et al, Polish Patent No. PL 165156; Hippe, S., Pesticide Science, 15:210-214 (1984); Thienpont et al., Arzneimittel-Forschung, 31:309-315 (1981); and Godefroi et al, German Patent No. DE 2063857. It is noted that prochloraz, another demethylation inhibitor, was approved for use on potatoes for a limited time as a co-formulation with another active ingredient. However, prochloraz is currently used on cereals and various other crops either on its own or as a complex with manganese.

In most cases, the features that are of greatest interest in fungicide development include improved movement of the fungicide within the plant to achieve greater uniformity of protection; in some circumstances increasing phloem-mobility and thereby enabling basipetal translocation; curative activity (for which translaminar or systemic activity is required, since otherwise the fungicide can only act on the target pathogen it penetrates plant tissue); persistence (which might be achieved by movement into plant tissue or into the cuticle/cuticular wax followed by gradual re-distribution from there); and overcoming resistance. These features are all mainly associated with modifying mobility. It is worth noting that, with the exception of fosetyl-aluminium and the phosphonates, systemic fungicides are all xylem-mobile, which means they are acropetally-translocated (i.e., the fungicides move up). They are not phloem-mobile, unlike herbicides, and therefore cannot move ‘down’ the plant to protect the roots if applied to foliage. Achieving basipetal translocation could be of interest in some circumstances. Xylem mobility is passive and largely a function of the hydrophobic/hydrophilic balance, which dictates how much of the molecule diffuses through the tissue and reaches the xylem, where it will then be moved in the sap stream.

The distinction between translaminar fungicides (i.e., fungicides which can move into and across leaf tissue, but theoretically don't move around the plant) and systemic fungicides, which can move around the plant, is not well defined. Like most things in biology, systemicity is a continuum and the extent of movement will depend on the specific fungicide and also the plant to which it is applied and the environmental conditions. However, non-systemic fungicides do not move into plant tissue to any significant extent, but rely on coating the surface. They tend to be hydrophobic and are usually multi-site inhibitors, which might well be toxic to the plant were they able to move into it.

In terms of modifying or increasing mobility within the plant, caution is needed, since one downside of such movement into plant tissue is the risk of phytotoxicity. In consequence of this, virtually all systemic/translaminar fungicides are single-site inhibitors, since this is required to achieve the requisite specificity. This specificity also puts them at a greater risk of development of resistance. A second potential downside is increased fungicide residues within the plant tissue, which is problematic in the case of crops produced for animal or human consumption. Increasing persistence also has a down-side, since if persistence in the environment was also increased, this would be undesirable. Ideally, compounds are needed that persist well in plant tissue and possess mobility within the plant, but then “disappear.” Methods of preparing these compositions are also needed. The compositions and methods described herein address these and other needs, including introducing additional biological functionality and reducing the number of required additional agents for application.

### SUMMARY

In accordance with the purposes of the disclosed materials, compounds, compositions, and methods, as embodied and broadly described herein, the disclosed subject matter, in one aspect, relates to compounds and compositions and methods for preparing and using such compounds and compositions. In a further aspect, the disclosed subject matter relates to fungicidal compositions. Methods for making the disclosed compositions are also disclosed. Also disclosed are methods of preparing compositions of active fungicidal ingredients. Further disclosed are methods of using the compositions described herein to improve fungicide penetration into the plant tissue, reduce fungicide volatility and drift, and decrease water solubility of the fungicides.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying Figures, which are incorporated in and constitute a part of this specification, illustrate several aspects described below.

FIG. 1 is a graph depicting the thermal stability of thiabendazolium docusate using thermogravimetrical analysis (TGA).

FIG. 2 is a graph depicting the melting point of thiabendazolium docusate using differential scanning calorimetry (DSC).

FIG. 3 shows pictures depicting the in vitro activity of thiabendazolium stearate using selected isolates of F. coreuleum and F. sulphureum.

FIG. 4 shows pictures depicting the in vitro activity of thiabendazolium docusate using selected isolates of F. coreuleum and F. sulphureum.

FIG. 5 shows pictures depicting the in vitro activity of thiabendazolium docusate, thiabendazolium stearate, and imazalilium docusate (at concentrations of, shown from bottom up, 0.5, 1, 5, 10, and 50 mg imazalil/L) using selected isolates of F. sulphureum.

FIG. 6 shows pictures depicting the in vitro activity of thiabendazolium docusate using selected isolates of F. coreuleum and F. sambucinum.

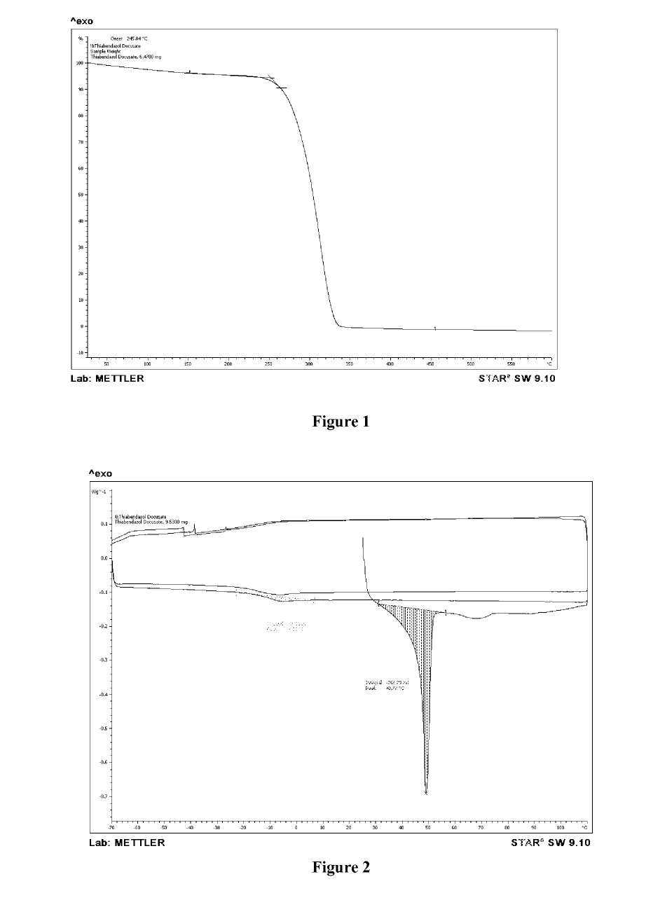

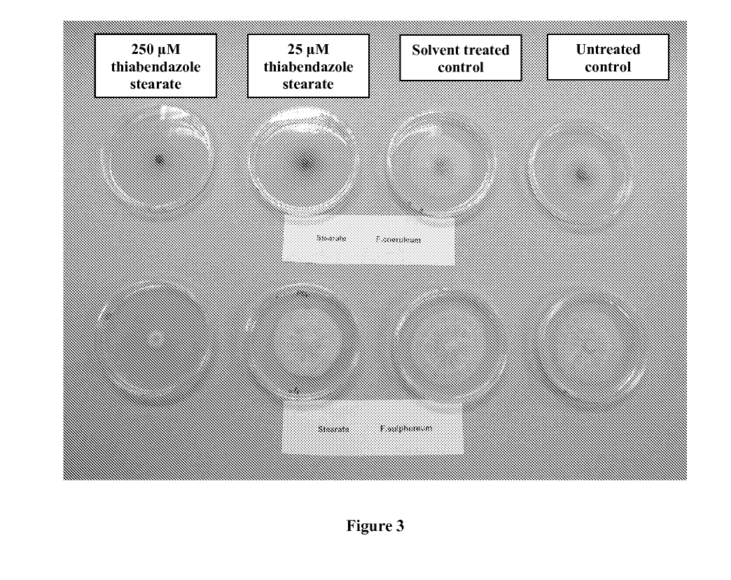

### DETAILED DESCRIPTION

Provided herein are compositions that include fungicides. The fungicidal compositions described herein contain cations and anions and possess dual functionality in which both the cation and the anion contribute different properties such as biological activity and physical properties to the composition. For example, the fungicidal compositions are designed to improve mobility of the fungicides and introduce additional biological function (e.g., penetration enhancement, stability, and hydrophobicity) to the fungicides. The dual functional compositions described herein can be derived from known fungicides and can retain at least the same activity as the corresponding commercial available compounds.

The disclosed compositions contain at least one kind of cation and at least one kind of anion. Examples of suitable cations and anions are disclosed herein. The anions and cations of the disclosed compositions can result in an ionic liquid. As such, the disclosed compositions in some aspects can be ionic liquids and can be used in that form. However, ionic liquids need not actually be prepared and used. Thus, in other aspects, a composition where cations and anions, which together are capable of forming an ionic liquid, are dissolved in a solution. While not wishing to be bound by theory, it is believed that as a result of the ionic liquid forming propensity of the particular cations and anions used, the fungicidal compositions described herein can achieve improved activity or synergistic effects, enhanced penetration, and controlled solubility and physical properties. In addition, the combination of two or more active chemicals in a single composition reduces the number of additional chemicals such as adjuvants or surfactants required per application, and can introduce secondary biological function.

The compounds, compositions, and methods described herein can be understood more readily by reference to the following detailed description of specific aspects of the disclosed subject matter and the Examples and Figures included therein.

Before the present compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### A. GENERAL DEFINITIONS

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an ionic liquid” includes mixtures of two or more such ionic liquids, reference to “the compound” includes mixtures of two or more such compounds, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, by “plants” is meant terrestrial plants and aquatic plants.

By “reduce” or other forms of the word, such as “reducing” or “reduction,” is meant lowering of an event or characteristic (e.g., fungal growth or survival). It is understood that this is typically in relation to some standard or expected value, in other words it is relative, but that it is not always necessary for the standard or relative value to be referred to. For example, “reduces plant growth” means decreasing the amount of plant relative to a standard or a control.

By “prevent” or other forms of the word, such as “preventing” or “prevention,” is meant to stop a particular event or characteristic, to stabilize or delay the development or progression of a particular event or characteristic, or to minimize the chances that a particular event or characteristic will occur. Prevent does not require comparison to a control as it is typically more absolute than, for example, reduce. As used herein, something could be reduced but not prevented, but something that is reduced could also be prevented. Likewise, something could be prevented but not reduced, but something that is prevented could also be reduced. It is understood that where reduce or prevent are used, unless specifically indicated otherwise, the use of the other word is also expressly disclosed.

By “treat” or other forms of the word, such as “treated” or “treatment,” is meant to administer a composition or to perform a method in order to reduce, prevent, inhibit, break-down, or eliminate a particular characteristic or event (e.g., fungal growth or survival). The term “control” is used synonymously with the term “treat.”

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### B. CHEMICAL DEFINITIONS

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., Zwitterions)). Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, deesterification, hydrolysis, etc.

The term “anion” is a type of ion and is included within the meaning of the term “ion.” An “anion” is any molecule, portion of a molecule (e.g., Zwitterion), cluster of molecules, molecular complex, moiety, or atom that contains a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., Zwitterion), cluster of molecules, molecular complex, moiety, or atom, that contains a net positive charge. The term “cation precursor” is used herein to specifically refer to a molecule that can be converted to a cation via a chemical reaction (e.g., protonation or alkylation).

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

The term “aliphatic” as used herein refers to a non-aromatic hydrocarbon group and includes branched and unbranched, alkyl, alkenyl, or alkynyl groups.

The term “alkyl” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkyl alcohol” is used in another, it is not meant to imply that the term “alkyl” does not also refer to specific terms such as “alkyl alcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term. The term “alkoxy” as used herein is an alkyl group bound through a single, terminal ether linkage; that is, an “alkoxy” group can be defined as —OA¹ where A¹ is alkyl as defined above.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This may be presumed in structural formulae herein wherein an asymmetric alkene is present, or it may be explicitly indicated by the bond symbol C═C. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “alkynyl” as used herein is a hydrocarbon group of 2 to 24 carbon atoms with a structural formula containing at least one carbon-carbon triple bond. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above, and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The term “aldehyde” as used herein is represented by the formula —C(O)H. Throughout this specification “C(O)” is a short hand notation for C═O.

The terms “amine” or “amino” as used herein are represented by the formula NA¹A²A³, where A¹, A², and A³ can be, independently, hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “carboxylic acid” as used herein is represented by the formula —C(O)OH. A “carboxylate” as used herein is represented by the formula —C(O)O⁻.

The term “ester” as used herein is represented by the formula —OC(O)A¹ or —C(O)OA¹, where A¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula A¹OA², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula A¹C(O)A², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” as used herein refers to the halogens fluorine, chlorine, bromine, and iodine.

The term “hydroxyl” as used herein is represented by the formula —OH.

The term “nitro” as used herein is represented by the formula —NO₂.

It is to be understood that the compounds provided herein may contain chiral centers. Such chiral centers may be of either the (R-) or (S-) configuration. The compounds provided herein may either be enantiomerically pure, or be diastereomeric or enantiomeric mixtures. It is to be understood that the chiral centers of the compounds provided herein may undergo epimerization in vivo. As such, one of skill in the art will recognize that administration of a compound in its (R-) form is equivalent, for compounds that undergo epimerization in vivo, to administration of the compound in its (S-) form.

As used herein, substantially pure means sufficiently homogeneous to appear free of readily detectable impurities as determined by standard methods of analysis, such as thin layer chromatography (TLC), nuclear magnetic resonance (NMR), gel electrophoresis, high performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound may, however, be a mixture of stereoisomers.

The term “bioactive property” is any local or systemic biological, physiological, or therapeutic effect in a biological system. For example, the bioactive property can be pesticidal, herbicidal, nutritional, antimicrobial, fungicidal, an algaecidal, insecticidal, miticidal, molluscicidal, nematicidal, rodenticidal, virucidal action, penetration enhancer, etc. Many examples of these and other bioactive properties are disclosed herein.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

Reference will now be made in detail to specific aspects of the disclosed compounds, compositions, and methods, examples of which are illustrated in the accompanying Figures and Examples.

### C. MATERIALS AND COMPOSITIONS

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), Sigma (St. Louis, Mo.), Pfizer (New York, N.Y.), GlaxoSmithKline (Raleigh, N.C.), Merck (Whitehouse Station, N.J.), Johnson & Johnson (New Brunswick, N.J.), Aventis (Bridgewater, N.J.), AstraZeneca (Wilmington, Del.), Novartis (Basel, Switzerland), Wyeth (Madison, N.J.), Bristol-Myers-Squibb (New York, N.Y.), Roche (Basel, Switzerland), Lilly (Indianapolis, Ind.), Abbott (Abbott Park, Ill.), Schering Plough (Kenilworth, N.J.), Akzo Nobel Chemicals Inc (Chicago, Ill.), Degussa Corporation (Parsippany, N.J.), Monsanto Chemical Company (St. Louis, Mo.), Dow Agrosciences LLC (Indianapolis, Ind.), DuPont (Wilmington, Del.), BASF Corporation (Florham Park, N.J.), Syngenta US (Wilmington, Del.), FMC Corporation (Philadelphia, Pa.), Valent U.S.A. Corporation (Walnut Creek, Calif.), Applied Biochemists Inc (Germantown, Wis.), Rohm and Haas Company (Philadelphia, Pa.), Bayer CropScience (Research Triangle Park, N.C.), or Boehringer Ingelheim (Ingelheim, Germany), or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989). Other materials can be obtained from commercial sources.

In one aspect, disclosed herein are ionic liquid compositions. The term “ionic liquid” has many definitions in the art, but is used herein to refer to salts (i.e., compositions comprising cations and anions) that are liquid at a temperature of at or below about 150° C. That is, at one or more temperature ranges or points at or below about 150° C. the disclosed ionic liquid compositions are liquid; although, it is understood that they can be solids at other temperature ranges or points (see Wasserscheid and Keim, Angew Chem Int Ed Engl, 2000, 39:3772; and Wasserscheid, “Ionic Liquids in Synthesis,” 1^{st} Ed., Wiley-VCH, 2002). Further, exemplary properties of ionic liquids are high ionic range, non-volatility, non-flammability, high thermal stability, wide temperature for liquid phase, highly solvability, and non-coordinating. For a review of ionic liquids see, for example, Welton, Chem. Rev. 1999, 99:2071-2083; and Carlin et al., Advances in Nonaqueous Chemistry, Mamantov et al. Eds., VCH Publishing, New York, 1994.

The term “liquid” describes the ionic liquid compositions that are generally in amorphous, non-crystalline, or semi-crystalline state. For example, while some structured association and packing of cations and anions can occur at the atomic level, the ionic liquid compositions can have minor amounts of such ordered structures and are therefore not crystalline solids. The compositions can be fluid and free-flowing liquids or amorphous solids such as glasses or waxes at temperatures at or below about 150° C. In particular examples described herein, the ionic liquid compositions are liquid at the temperature at which the composition is applied (i.e., ambient temperature).

Further, the disclosed ionic liquid compositions are materials composed of at least two different ions, each of which can independently and simultaneously introduce a specific characteristic to the composition not easily obtainable with traditional dissolution and formulation techniques. Thus, by providing different ions and ion combinations, one can change the characteristics or properties of the disclosed ionic liquid compositions in a way not seen by simply preparing various crystalline salt forms.

Examples of characteristics that can be controlled in the disclosed compositions include, but are not limited to, melting point, solubility control, stability, and biological activity or function. It is this multi-nature/functionality of the disclosed ionic liquid compositions which allows one to fine-tune or design in very specific desired material properties.

It is further understood that the disclosed ionic liquid compositions can include solvent molecules (e.g., water); however, these solvent molecules are not required to be present in order to form the ionic liquids. That is, the disclosed ionic liquid compositions can contain, at some point during preparation and application no or minimal amounts of solvent molecules that are free and not bound or associated with the ions present in the ionic liquid composition. The disclosed ionic liquid compositions can, after preparation, be further diluted with solvent molecules (e.g., water) to form a solution suitable for application. Thus, the disclosed ionic liquid compositions can be liquid hydrates, solvates, or solutions. In regard to the solutions, they need not be referred to as an original from a diluted ionic liquid. The solutions disclosed herein can arise by separately dissolving the cations and anions in a solvent. It is understood that solutions formed by diluting ionic liquids or by separately dissolving the cations and anions that could form an ionic liquid possess enhanced chemical properties that are unique to ionic liquid-derived solutions.

The specific physical properties (e.g., melting point, viscosity, density, water solubility, etc.) of ionic liquids are determined by the choice of cation and anion, as is disclosed more fully herein. As an example, the melting point for an ionic liquid can be changed by making structural modifications to the ions or by combining different ions. Similarly, the particular chemical properties (e.g., toxicity, bioactivity, etc.), can be selected by changing the constituent ions of the ionic liquid.

Since many ionic liquids are known for their non-volatility, thermal stability, and ranges of temperatures over which they are liquids, the numerous deficiencies of fungicides can be addressed through the formation of ionic liquids or solutions of ions that are capable of forming ionic liquids, rather than covalent modification of the active fungicide itself. The compositions disclosed herein are comprised of at least one kind of anion and at least one kind of cation. In these compositions, either the at least one kind of anion and the at least one kind of cation can possess a fungicidal property (i.e., can be a fungicidal active). The other of the at least one kind of anion or the at least one kind of cation can possess a bioactive property. For example, the anion or cation possessing the bioactive property can be a second fungicidal active, a pesticidal active, an herbicidal active, an antimicrobial active, an algaecide, an insecticide, a miticide, a molluscicide, a nematicide, a rodenticide, a virucide, or the like, including any combination thereof, as is disclosed herein. It is contemplated that the disclosed ionic liquid compositions can comprise one kind of cation with more than one kind of anion (e.g., 2, 3, 4, 5, 6, 7, 8, 9, 10 or more different anions). Likewise, it is contemplated that the disclosed ionic liquid compositions can comprise one kind of anion with more than one kind of cation (e.g., 2, 3, 4, 5, 6, 7, 8, 9, 10, or more different kinds of cations). Further, the disclosed ionic liquids can comprise more than one kind of anion (e.g., 2, 3, 4, 5, 6, 7, 8, 9, 10, or more different kinds of anions) with more than one kind of cation (e.g., 2, 3, 4, 5, 6, 7, 8, 9, 10 or more different kinds of cations). Specific examples include, but are not limited to, one kind of cation with 1, 2, 3, 4, 5, 6, 7, 8, 9, 10, or more kind of anions, 2 kinds of cations with 1, 2, 3, 4, 5, 6, 7, 8, 9, 10, or more kinds of anions, 3 kinds of cations with 1, 2, 3, 4, 5, 6, 7, 8, 9, 10, or more kinds of anions, 4 kinds of cations with 1, 2, 3, 4, 5, 6, 7, 8, 9, 10, or more kinds of anions, 5 kinds of cations with 1, 2, 3, 4, 5, 6, 7, 8, 9, 10, or more kinds of anions, 6 kinds of cations with 1, 2, 3, 4, 5, 6, 7, 8, 9, 10, or more kinds of anions, 7 kinds of cations with 1, 2, 3, 4, 5, 6, 7, 8, 9, 10, or more kinds of anions, 8 kinds of cations with 1, 2, 3, 4, 5, 6, 7, 8, 9, 10, or more kinds of anions, 9 kinds of cations with 1, 2, 3, 4, 5, 6, 7, 8, 9, 10, or more kinds of anions, 10 kinds of cations with 1, 2, 3, 4, 5, 6, 7, 8, 9, 10, or more kinds of anions, or more than 10 kinds of cations with 1, 2, 3, 4, 5, 6, 7, 8, 9, 10, or more kinds of anions.

Other specific examples include, but are not limited to, one kind of anion with 1, 2, 3, 4, 5, 6, 7, 8, 9, 10, or more kinds of cations, 2 kinds of anions with 1, 2, 3, 4, 5, 6, 7, 8, 9, 10, or more kinds of cations, 3 kinds of anions with 1, 2, 3, 4, 5, 6, 7, 8, 9, 10, or more kinds of cations, 4 kinds of anions with 1, 2, 3, 4, 5, 6, 7, 8, 9, 10, or more kinds of cations, 5 kinds of anions with 1, 2, 3, 4, 5, 6, 7, 8, 9, 10, or more kinds of cations, 6 kinds of anions with 1, 2, 3, 4, 5, 6, 7, 8, 9, 10, or more kinds of cations, 7 kinds of anions with 1, 2, 3, 4, 5, 6, 7, 8, 9, 10, or more kinds of cations, 8 kinds of anions with 1, 2, 3, 4, 5, 6, 7, 8, 9, 10, or more kinds of cations, 9 kinds of anions with 1, 2, 3, 4, 5, 6, 7, 8, 9, 10, or more kinds of cations, 10 kinds of anions with 1, 2, 3, 4, 5, 6, 7, 8, 9, 10, or more kinds of cations, or more than 10 kinds of anions with 1, 2, 3, 4, 5, 6, 7, 8, 9, 10, or more kinds of cations.

In addition to the cations and anions, the compositions disclosed herein can also contain nonionic species, such as solvents, preservatives, dyes, colorants, thickeners, surfactants, viscosity modifiers, mixtures and combinations thereof and the like. The amount of such nonionic species can range from less than about 99, 90, 80, 70, 60, 50, 40, 30, 20, or 10 wt. % based on the total weight of the composition. In some examples described herein, the amount of such nonionic species is low (e.g., less than about 10, 9, 8, 7, 6, 5, 4, 3, 2, or 1 wt. % based on the total weight of the composition). In some examples described herein, the disclosed ionic liquid compositions are neat; that is, the only materials present in the disclosed ionic liquids are the cations and anions that make up the ionic liquids. It is understood, however, that with neat compositions, some additional materials or impurities can sometimes be present, albeit at low to trace amounts (e.g., less than about 10, 9, 8, 7, 6, 5, 4, 3, 2, or 1 wt. % based on the total weight of the composition).

The disclosed compositions, when in ionic liquid form, are liquid at some temperature range or point at or below about 150° C. For example, the disclosed ionic liquids can be a liquid at or below about 150, 149, 148, 147, 146, 145, 144, 143, 142, 141, 140, 139, 138, 137, 136, 135, 134, 133, 132, 131, 130, 129, 128, 127, 126, 125, 124, 123, 122, 121, 120, 119, 118, 117, 116, 115, 114, 113, 112, 111, 110, 109, 108, 107, 106, 105, 104, 103, 102, 101, 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, −40, −41, −42, −43, −44, −45, −46, −47, −48, −49, −50, −51, −52, −53, −54, −55, −56, −57, −58, −59, −60, −61, −62, −63, −64, −65, −66, −67, −68, −69, −70, −71, −72, −73, −74, −75, −76, −77, −78, −79, −80, −81, −82, −83, −84, −85, −86, −87, −88, −89, −90, −91, −92, −93, −94, −95, −96, −97, −98, −99, or −100° C., where any of the stated values can form an upper or lower endpoint of a range. In further examples, the disclosed ionic liquids can be liquid at any point from about −30° C. to about 150° C., from about −20° C. to about 140° C., from about −10° C. to about 130° C., from about 0° C. to about 120° C., from about 10° C. to about 110° C., from about 20° C. to about 100° C., from about 30° C. to about 90° C., from about 40° C. to about 80° C., from about 50° C. to about 70° C., from about −30° C. to about 50° C., from about −30° C. to about 90° C., from about −30° C. to about 110° C., from about −30° C. to about 130° C., from about −30° C. to about 150° C., from about 30° C. to about 90° C., from about 30° C. to about 110° C., from about 30° C. to about 130° C., from about 30° C. to about 150° C., from about 0° C. to about 100° C., from about 0° C. to about 70° C., from about 0° to about 50° C., and the like.

Further, in some examples the disclosed ionic liquid compositions can be liquid over a wide range of temperatures, not just a narrow range of, for example, 1-2 degrees. For example, the disclosed ionic liquid compositions can be liquids over a range of at least about 4, 5, 6, 7, 8, 9, 10, or more degrees. In other examples, the disclosed ionic liquid compositions can be liquid over at least about an 11, 12, 13, 14, 15, 16, 17, 18, 19, 20, or more degree temperature range. Such temperature ranges can begin and/or end at any of the temperature points disclosed in the preceding paragraph.

In many examples disclosed herein, the disclosed ionic liquid compositions are liquid at the temperature at which they will be used or processed. For example, many of the disclosed ionic liquid compositions can be used as fungicides, which are liquid at the temperature of their use (e.g., ambient temperature). In other examples, the disclosed compositions can be liquid at the temperature at which they are formulated or processed.

As described above, it is understood that the disclosed ionic liquid compositions can be solubilized and solutions of the cations and anions are contemplated herein. Further, the disclosed compositions can be formulated in an extended or controlled release vehicle, for example, by encapsulating the compositions in microspheres or microcapsules using methods known in the art. Still further, the disclosed compositions can themselves be solvents for other solutes. For example, the disclosed compositions can be used to dissolve a particular nonionic or ionic fungicidal active. These and other formulations of the disclosed compositions are disclosed elsewhere herein.

The disclosed compositions can be substantially free of water in some examples (e.g., immediately after preparation of the compositions and before any further application of the compositions). By substantially free is meant that water is present at less than about 10, 9, 8, 7, 6, 5, 4, 3, 2, 1, 0.5, 0.25, or 0.1 wt. %, based on the total weight of the composition.

The disclosed compositions can be prepared by methods described herein. Generally, the particular cation(s) and anion(s) used to prepare an ionic liquid are selected as described herein. Then, with the particular cation(s) and anion(s) in hand, they can be added (in any order) to a solvent or combined, resulting in ionic liquid compositions as disclosed herein. The resulting ionic liquid can be then used in the ionic liquid form or diluted in a suitable solvent as described herein. Additionally, the method for the preparation of the disclosed compositions can include the reaction in which two neutral species: an anion precursor (e.g., in the form of an inorganic acid, carboxylic organic acid, non-carboxylic acid, or Zwitterion species) and a cation precursor (e.g., an inorganic base, an organic base, or a Zwitterion species) are combined resulting in ionic liquid compositions as disclosed herein. Again, such an ionic liquid can be used as is or diluted in an appropriate solvent. Still further, the disclosed compositions can be prepared by mixing in solution cations and anions, wherein the cations and anions are capable of forming an ionic liquid, albeit under different nonsolvating conditions.

Providing ions used to prepare the disclosed compositions depends, in one aspect, on the desired properties of the resulting composition. As described herein, the disclosed compositions can have multiple desired properties, which, at least in part, come from the properties of the cation(s) and anion(s) used to prepare the compositions. Thus, to prepare the disclosed compositions, one or more kinds of cations with a desired property(ies) are provided. One or more anions with a desired property(ies) that is similar or different to that of the cation(s) can likewise be provided, as long as one of the anions or cations contains a fungicidal property. Of course, providing a desired anion(s) and a cation(s) can be done in any order, depending on the preference and aims of the practitioner. For example, a particular cation(s) can be provided and then a particular anion(s) can be provided. Alternatively, a particular anion(s) can be provided and then a particular cation(s) can be provided. Further, the cation(s) and anion(s) can be provided simultaneously.

As noted, providing a suitable ion can be based on selecting an ion that possesses a property that is desired (e.g., the ion has a property that is desired to be possessed by the resulting compositions). Most preferably, the particular cations and anions are chosen such that they have the ability to form an ionic liquid, though they need not be actually used in that particular form. Moreover, each ion in the compositions contributes to distinctive physical, chemical, and biological properties of the resulting salt, and thus, ionic liquid fungicides can be fine-tuned to overcome unfortunate problems in use while maintaining the biological efficacy of the active ingredient. Examples of other properties that could be desired in a suitable cation and/or anion (and thus the compositions made therefrom) include, but are not limited to, fungicidal, herbicidal, and pesticidal (e.g., antimicrobial, algaecidal, insecticidal, miticidal, molluscicidal, nematicidal, rodenticidal, and virucidal) activity. Viscosity modulation, solubility modulation, stability, and hydrophobicity are other properties of a given ion that could be desired and considered. While more specific properties are disclosed elsewhere herein, the disclosed methods and compositions are not limited to any particular combination of properties, as such will depend on the preferences and goals of the practitioner.

Typically, the desired properties of the cation(s) and anion(s) will be different or complimentary to one another. In this way, the resulting compositions can possess multiple desired properties: those properties imparted by the cation(s) and those imparted by the anion(s). In other words, some or all of the ions present in the disclosed compositions can independently and simultaneously introduce a specific functionality or property to the disclosed compositions. It is this multiple functionality characteristic that can allow one to fine-tune or design very specific physical, chemical, and bioactive properties in the disclosed fungicidal compositions. Additional functionality can be obtained by using the disclosed fungicidal compositions as solvents to dissolve a solute(s) with another desired property, thus resulting in a solution where the ions of the compositions as well as the solute contribute desired properties to the composition. General and specific examples of various combinations of ions and their associated properties are disclosed herein.

In some particular examples, one or more ions in the disclosed compositions (e.g., the anions, cations, or both) can be a fungicidal active, e.g., an existing fungicide that is ionic or that can be made ionic. Many fungicides exist naturally or at physiological conditions as an ion, or they can be converted to ions via simple chemical transformations (e.g., alkylation, protonation, deprotonation, etc.). As such, these fungicides can be used to prepare a composition as disclosed herein. Such fungicides can further possess additional bioactive properties, many of which are described herein. Combining such fungicides with other ions to prepare an ionic liquid, as is disclosed herein, can result in the modification and/or enhancement of the fungicides' properties. Similarly, combining in solution these particular combinations of ions can also result in modification and/or enhancement of the fungicides' properties. For example, a first fungicide ion with a given property can be combined with an oppositely charged second ion with another property to effect the slow or controlled release, slow or controlled delivery, or desired physical properties (stability, solubility, toxicity, melting point, etc.), in the fungicidal formulation. In this way, new fungicide compositions can be created by forming ionic liquids or solutions with functionality crafted into the combination of the ions, as disclosed herein.

As another example, the first fungicidal anion or cation may be combined with a second anion or cation that has properties complementary to the first. Examples of this can include, but are not limited to, an ion having fungicidal properties being combined with an ion having antimicrobial properties, an ion having fungicidal properties being combined with a second ion having fungicidal properties, or an ion having fungicidal properties being combined with an ion having pesticidal properties. Ionic liquids or solutions resulting from such combinations can find uses as multi-purposed crop protection agents, for example. Further examples can include two differently charged ions each with similar uses but with different mechanisms of action. Specific examples of such combinations can include, but are not limited to, combinations of ions with selective fungicidal properties and/or non-selective fungicidal properties. According to the methods and compositions disclosed herein, ion identification and combination can involve any ion as long as the combination would result in an ionic liquid. As should be appreciated, the various combinations of ions according to the disclosed methods are numerous, and depend only on the desired combination of properties and whether the resulting ion combination is an ionic liquid as defined herein.

### Ions

The disclosed compositions can contain at least one kind of anion and at least one kind of cation, provided either the anion or the cation possesses fungicidal properties. In some examples, the compositions can contain at least one fungicidal cation. In other examples, the compositions can contain at least one fungicidal anion. Examples of suitable anions and cations are disclosed herein. It should be understood that when a particular compound is disclosed as being a cation, for example, it can also, in other circumstances, be an anion and vice versa. Many compounds are known to exist as cations in some environments and anions in other environments. Further, many compounds are known to be convertible to cations and anions through various chemical transformations. Examples of such compounds are disclosed herein.

The materials, compounds, compositions, and components that can be used for, can be used in conjunction with, can be used in preparation for, or are products of the disclosed methods and compositions are disclosed herein. It is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the compositions are discussed, each and every combination and permutation that are possible are specifically contemplated unless specifically indicated to the contrary. Thus, if a class of cations A, B, and C are disclosed as well as a class of anions D, E, and F and an example of a ionic liquid A-D is disclosed, then even if each is not individually recited, each is individually and collectively contemplated. Thus, in this example, each of the ionic liquids A-E, A-F, B-D, B-E, B-F, C-D, C-E, and C-F are specifically contemplated and should be considered disclosed from disclosure of A, B, and C; D, E, and F; and the example ionic liquid A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

### Fungicidal Ions

As described above, the at least one anion or the at least one cation can include fungicidal ions (e.g., a fungicidal anion and/or a fungical cation). An example of a fungicidal anion includes ethylenbis(dithiocarbamate) as shown below.

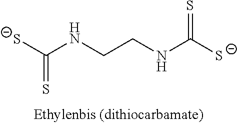

Examples of fungicidal cations include thiabendazole, carbendazim, prochloraz, propamocarb, fluazinam, imazalil, and benthiavalicarb-isopropyl as shown below.

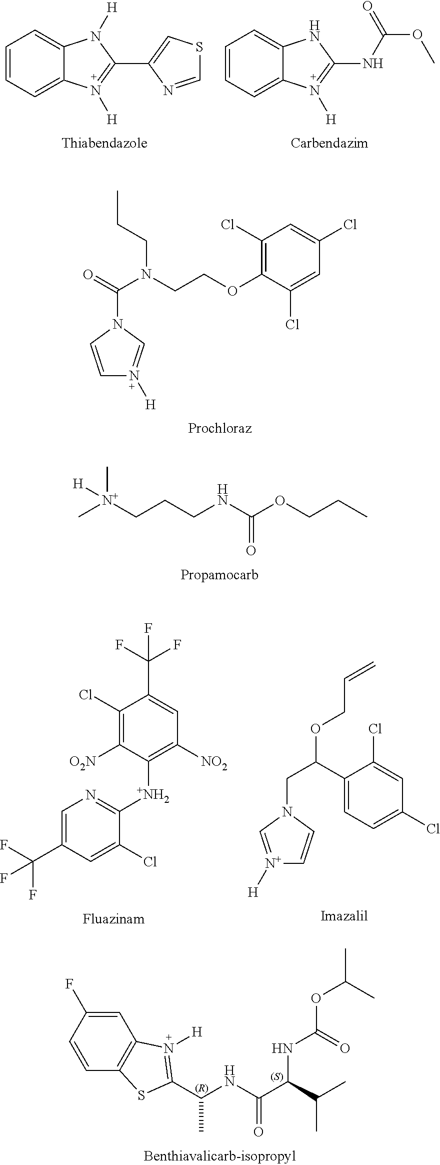

Further examples of fungicides that can be included as a cation or as an anion in the compositions described herein include aliphatic nitrogen fungicides, amide fungicides, acylamino acid fungicides, furamide fungicides, phenylsulfamide fungicides, valinamide fungicides, anilide fungicides, benzanilide fungicides, furanilide fungicides, sulfonanilide fungicides, antibiotic fungicides, strobilurin fungicides, aromatic fungicides, benzimidazole fungicides, benzimidazole precursor fungicides, benzothiazole fungicides, bridged diphenyl fungicides, carbamate fungicides, benzimidazolylcarbamate fungicides, carbanilate fungicides, conazole fungicides such as imidazole and triazole conazole fungicides, dicarboximide fungicides, dinitrophenol fungicides, dithiocarbamate fungicides, cyclic dithiocarbamate fungicides, polymeric dithiocarbamate fungicides, imidazole fungicides, morpholine fungicides, organophosphorus fungicides, oxathin fungicides, oxazole fungicides, polysulfide fungicides, pyridine fungicides, pyrimidine fungicides, pyrrole fungicides, quinoline fungicides, quinone fungicides, quinoxaline fungicides, thiazole fungicides, thiocarbamate fungicides, thiophene fungicides, triazine fungicides, triazole fungicides, urea fungicides, and other unclassified fungicides.

Specific examples of aliphatic nitrogen fungicides include butylamine, cymoxanil, dodicin, dodine, guazatine, and iminoctadine. Amide fungicides include carpropamid, chloraniformethan, cyazofamid, cyflufenamid, diclocymet, ethaboxam, fenoxanil, flumetover, furametpyr, quinazamid, silthiofam, and triforine. Specific examples of acylamino acid fungicides include benalaxyl, benalaxyl-M, furalaxyl, metalaxyl, metalaxyl-M, and pefurazoate. Benzamide fungicides include benzohydroxamic acid, tioxymid, trichlamide, zarilamid, zoxamide. Examples of furamide fungicides include cyclafuramid, furmecyclox. Specific examples of phenylsulfamide fungicides include dichlofluanid and tolylfluanid. Valinamide fungicides include iprovalicarb. Examples of anilide fungicides include benalaxyl, benalaxyl-M boscalid, carboxin, fenhexamid, metalaxyl, metalaxyl-M, metsulfovax, ofurace, oxadixyl, oxycarboxin, pyracarbolid, thifluzamide, and tiadinil.

Specific examples of benzanilide fungicides include benodanil, flutolanil, mebenil, mepronil, salicylanilide, and tecloftalam. Furanilide fungicides include fenfuram, furalaxyl, furcarbanil and methfuroxam. Examples of sulfonanalide fungicides include flusulfamide.

Specific examples of antibotic fungicides include aureofungin, blasticidin-S, cycloheximide, griseofulvin, kasugamycin, natamycin, polyoxins, polyoxorim, streptomycin, and validamycin. Strobilurin fungicides include azoxystrobin, dimoxystrobin, fluoxastrobin, kresoxim-methyl, metominostrobin, orysastrobin, picoxystrobin, pyraclostrobin, and trifloxystrobin.

Specific examples of aromatic fungicides include biphenyl, chlorodinitronaphthalene, chloroneb, chlorothalonil, cresol, dicloran, hexachlorobenzene, pentachlorophenol, quintozene, sodium pentachlorophenoxide, and tecnazene. Benzimidazole fungicides include benomyl, carbendazim, chlorfenazole, cypendazole, debacarb, fuberidazole, mecarbinzid, and rabenzazole. Examples of benzimidazole precursor fungicides include furophanate, thiophanate, and thiophanate-methyl.

Specific examples of benzothiazole fungicides include bentaluron, chlobenthiazone, and TCMTB. Specific examples of bridged diphenyl fungicides include bithionol, dichlorophen, and diphenylamine Specific examples of carbamate fungicides include benthiavalicarb, furophanate, iprovalicarb, thiophanate, and thiophanate-methyl. Benzimidazolylcarbamate fungicides include benomyl, carbendazim, cypendazole, debacarb, and mecarbinzid. Examples of carbanilate fungicides include diethofencarb.

Specific examples of conazole imidazole fungicides include climbazole, clotrimazole, oxpoconazole, prochloraz, and triflumizole. Specific examples of conazole triazole fungicides include azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

Examples of dicarboximide fungicides include famoxadone, fluoroimide. Specific examples of dichlorophenyl dicarboximide fungicides include chlozolinate, dichlozoline, iprodione, isovaledione, myclozolin, procymidone, and vinclozolin. Specific examples of phthalimide fungicides include captafol, captan, ditalimfos, folpet, and thiochlorfenphim. Specific examples of dinitrophenol fungicides include binapacryl, dinobuton, dinocap, dinocap-4, dinocap-6, dinocton, dinopenton, dinosulfon, dinoterbon, and DNOC. Examples of dithiocarbamate fungicides include azithiram, carbamorph, cufraneb, cuprobam, disulfuram, ferbam, metam, nabam, tecoram, thiram, and ziram. Specific examples of cyclic dithiocarbamate fungicides include dazomet, etem, and milneb. Polymeric dithiocarbamate fungicides include mancopper, mancozeb, maneb, metiram, polycarbamate, propineb, and zineb. Specific examples of imidazole fungicides include cyazofamid, fenamidone, fenapani, glyodin, iprodione, isovaledione, pefurazoate, triazoxide.

Specific examples of morpholine fungicides include aldimorph, benzamorf, carbamorph, dimethomorph, dodemorph, fenpropimorph, flumorph, and tridemorph. Examples of organophosphorus fungicides include ampropylfos, ditalimfos, edifenphos, fosetyl, hexylthiofos, iprobenfos, phosdiphen, pyrazophos, tolclofos-methyl, and triamiphos. Specific examples of oxathiin fungicides include carboxin, and oxycarboxin.

Oxazole fungicides include chlozolinate, dichlozoline, drazoxolon, famoxadone, hymexazol, metazoxolon, myclozolin, oxadixyl, vinclozolin. Examples of polysulfide fungicides include barium polysulfide, calcium polysulfide, potassium polysulfide, and sodium polysulfide. Specific examples of pyridine fungicides include boscalid, buthiobate, dipyrithione, pyridimtril, pyrifenox, pyroxychlor, and pyroxyfur. Pyrimidine fungicides include bupirimate, cyprodinil, diflumetorim, dimethirimol, ethirimol, fenarimol, ferimzone, mepanipyrim, nuarimol, pyrimethanil, and triarimol. Examples of pyrrole fungicides include fenpiclonil, fludioxonil, and fluoroimide.

Specific examples of quinoline fungicides include ethoxyquin, halacrinate, 8-hydroxyquinoline sulfate, quinacetol, and quinoxyfen. Examples of quinone fungicides include benquinox, chloranil, dichlone, and dithianon. Quinoxaline fungicides include chinomethionat, chlorquinox, and thioquinox. Specific examples of thiazole fungicides include ethaboxam, etridiazole, metsulfovax, octhilinone, thiabendazole thiadifluor, and thifluzamide. Thiocarbamate fungicides include methasulfocarb and prothiocarb. Examples of thiophene fungicides include ethaboxam, and silthiofam. Specific examples of triazine fungicides include anilazine. Triazole fungicides include bitertanol, fluotrimazole, and triazbutil. Examples of urea fungicides include bentaluron, pencycuron, and quinazamid.

Specific examples of other unclassified fungicides include acibenzolar, acypetacs, allyl alcohol, benzalkonium chloride, benzamacril, bethoxazin, carvone, chloropicrin, DBCP, dehydroacetic acid, diclomezine, diethyl pyrocarbonate, fenaminosulf, fenitropan, fenpropidin, formaldehyde, furfural, hexachlorobutadiene, iodomethane, isoprothiolane, methyl bromide, methyl isothiocyanate, metrafenone, nitrostyrene, nitrothal-isopropyl, OCH, 2-phenylphenol, phthalide, piperalin, probenazole, proquinazid, pyroquilon, sodium orthophenylphenoxide, spiroxamine, sultropen, thicyofen, tricyclazole, and zinc naphthenate.

### Bioactive Ions

In addition to the fungicidal ion (e.g., those just listed in the section above), the counterion(s) (which is the opposite charge to the selected fungicidal ion), i.e., the at least one anion or the at least one cation, can include a bioactive ion (e.g., a bioactive anion or a bioactive cation). By “bioactive ion” is meant an ion with a charge opposite of that of the fungicidal anion. For example, in a composition containing a fungicidal cation, the composition can include a bioactive anion. Likewise, in a composition containing a fungicidal anion, the composition can include a bioactive cation. Bioactive anions can include surfactants and penetration enhancers such as fatty acid anions and anionic PEG compounds. Examples of useful penetration enhancers include the following anions as shown below.

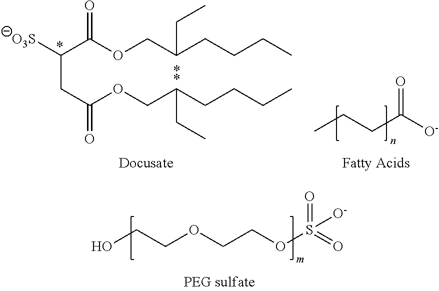

In the fatty acids and PEG sulfate general structures shown above, n is an integer from 1 to 40 and m is an integer from 2 to 2000.

Particular examples of cationic compounds that can be present in the disclosed compositions as bioactive cations are compounds that contain nitrogen or phosphorus atoms. Nitrogen atom-containing groups can exist as neutral or can be converted to positively-charged quaternary ammonium species, for example, through alkylation or protonation of the nitrogen atom. Thus, compounds that possess a quaternary nitrogen atom (known as quaternary ammonium compounds (QACs)) are typically cations. According to the methods and compositions disclosed herein, any compound that contains a quaternary nitrogen atom or a nitrogen atom that can be converted into a quaternary nitrogen atom can be a suitable cation for the disclosed compositions. In some examples, the cation is not a protonated amine or a metal.

QACs can have numerous biological properties that one may desire to be present in the disclosed compositions. For example, many QACs are known to have antibacterial properties. The antibacterial properties of QACs were first observed toward the end of the 19^{th} century among the carbonium dyestuffs, such as auramin, methyl violet, and malachite green. These types of compounds are effective chiefly against the Gram-positive organisms. Jacobs and Heidelberger first discovered QACs antibacterial effect in 1915 studying the antibacterial activity of substituted hexamethylene-tetrammonium salts (Jacobs and Heidelberger, Proc Nat Acad Sci USA, 1915, 1:226; Jacobs and Heidelberger, J Biol Chem, 1915, 20:659; Jacobs and Heidelberger, J Exptl Med, 1916, 23:569).

Browning et al. found great and somewhat less selective bactericidal powers among quaternary derivatives of pyridine, quinoline, and phenazine (Browning et al., Proc Roy Soc London, 1922, 93B:329; Browning et al., Proc Roy Soc London, 1926, 100B:293). Hartman and Kagi observed antibacterial activity in QACs of acylated alkylene diamines (Hartman and Kagi, Z Angew Chem, 1928, 4:127).

In 1935, Domagk synthesized long-chain QACs, including benzalkonium chloride, and characterized their antibacterial activities (Domagk, Deut Med Wochenschr, 1935, 61:829). He showed that these salts are effective against a wide variety of bacterial strains. This study of the use of QACs as germicides was greatly stimulated.

Many scientists have focused their attention on water soluble QACs because they exhibit a range of properties: they are surfactants, they destroy bacteria and fungi, they serve as a catalyst in phase-transfer catalysis, and they show anti-electrostatic and anticorrosive properties. They exert antibacterial action against both Gram-positive and Gram-negative bacterial as well as against some pathogen species of fungi and protozoa. These multifunctional salts have also been used in wood preservation, their application promoted in the papers of Oertel and Butcher et al. (Oertel, Holztechnologie, 1965, 6:243; Butcher et al., For Prod J, 1977, 27:19; Butcher et al., J For Sci, 1978, 8:403). Many examples of compounds having nitrogen atoms, which exist as quaternary ammonium species or can be converted into quaternary ammonium species, are disclosed herein.

Some specific QACs suitable for use herein include aliphatic heteroaryls (i.e., a compound that comprises at least one aliphatic moiety bonded to a heteroaryl moiety), aliphatic benzylalkyl ammonium cation (i.e., a cation that comprises an aliphatic moiety bonded to the nitrogen atom of a benzylalkyl amine moiety), dialiphatic dialkyl ammonium cations (i.e., a compound that comprises two aliphatic moieties and two alkyl moieties bonded to a nitrogen atom), a tetraalkyl ammonium cation, or other quaternary ammonium cations.

The bioactive ions can also include substituted or unsubstituted pyrazoles, substituted or unsubstituted pyridines, substituted or unsubstituted pyrazines, substituted or unsubstituted pyrimidines, substituted or unsubstituted pryidazines, substituted or unsubstituted indolizines, substituted or unsubstituted isoindoles, substituted or unsubstituted indoles, substituted or unsubstituted indazoles, substituted or unsubstituted imidazoles, substituted or unsubstituted oxazoles, substituted or unsubstituted triazoles, substituted or unsubstituted thiazoles, substituted or unsubstituted purines, substituted or unsubstituted isoquinolines, substituted or unsubstituted quinolines, substituted or unsubstituted phthalazines, substituted or unsubstituted quinooxalines, substituted or unsubstituted phenazine, and the like, including derivatives and mixtures thereof. Further examples include substituted or unsubstituted benztriazoliums, substituted or unsubstituted benzimidazoliums, substituted or unsubstituted benzothiazoliums, substituted or unsubstituted pyridiniums, substituted or unsubstituted pyridaziniums, substituted or unsubstituted pyrimidiniums, substituted or unsubstituted pyraziniums, substituted or unsubstituted imidazoliums, substituted or unsubstituted pyrazoliums, substituted or unsubstituted oxazoliums, substituted or unsubstituted 1,2,3-triazoliums, substituted or unsubstituted 1,2,4-triazoliums, substituted or unsubstituted thiazoliums, substituted or unsubstituted piperidiniums, substituted or unsubstituted pyrrolidiniums, substituted or unsubstituted quinoliums, and substituted or unsubstituted isoquinoliums.

An example of a suitable bioactive cation includes the following structure:

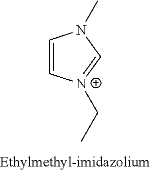

### Specific Compositions

Because the disclosed compositions can have multiple functionalities or properties, each arising from the various ions that make up the compositions, the disclosed compositions can be custom designed for numerous uses. As disclosed herein, any combination of cations and anions, as disclosed herein, can be made as long as the combination would result in an ionic liquid as described herein. That is, any compound or active disclosed herein that has a given charge or can be made to have a given charge (the “first ion(s)”) and can be combined with any other compound or active disclosed herein having a charge opposite to that of the first ion(s) or any compound that can be made to have a charge opposite to that of the first ion(s) to form an ionic liquid is suitable. Thus, in many examples, the compositions can have one type of cation and one type of anion, in a 1:1 relationship, so that the net charge of the ionic liquid is zero.

Furthermore, many of the ions disclosed herein can have multiple charges. Thus, when one ion having a multiple charge is used, more counterion is needed, which will affect the ratio of the two ions. For example, if a cation having a plus 2 charge is used, then twice as much anion having a minus 1 charge is needed. If a cation having a plus 3 charge is used, then three times as much anion having a minus 1 charge is needed, and so on. While the particular ratio of ions will depend on the type of ion and their respective charges, the disclosed compositions can have a cation to anion ratio of 1:1, 2:1, 3:1, 4:1, 1:2, 1:3, 3:2, 2:3, and the like.

Many of the compositions disclosed herein can also have more than one different kind of cation and/or more than one different kind of anion. The use of more than one kind of cation and/or anion can be particularly beneficial when one prepares a composition comprising two or more bioactive ions that are not desired to be in a 1:1 relationship. In other words, according to the disclosed methods, the disclosed compositions that contain varying effective amounts of active substances can be prepared by varying the ratios of ions in the composition, as long as the total amount of cations is balanced by the total amount of anions. For example, a composition as disclosed herein can contain one type of cation with a given property and two different anions (e.g., a first and second anion), each with another different property. The resulting ionic liquid in this example will be 1 part cation, 0.5 part first anion, and 0.5 part second anion. Another example of this adjustment in ion amounts can arise when one ion is particularly potent and thus dilution is desired. For example, a first cation that is particularly potent can be combined with a second (or third, forth, etc.) cation that is inert or has so other property that is desired. When these cations are combined with one or more anions to form an ionic liquid, the amount of the first cation is diluted by the other the cation(s). As will be appreciated, many other such variations in the amount of cations and anions can be present in the disclosed methods and compositions. Thus, while specific ionic liquid compositions having particular combinations of cations and anions are disclosed herein, it is understood that the ratio of the particular ions can be varied or adjusted by adding other ions, so long as there is a balance of charge and the final composition is an ionic liquid. Moreover, solutions of these combinations of ions are also contemplated herein, whether prepared by diluting an ionic liquid that was prepared beforehand or by mixing the ions directly into solution.

When the disclosed compositions have two or more ions with a bioactive property (e.g., fungicidal actives, herbicidal actives, antimicrobials, and the like), these compositions can be particularly desired because each of the active ingredients in the composition would dissolve together when formulated or administered. This can be particularly useful when overcoming formulation, solubility, mobility, and size issues. As noted above, for example, if one active ingredient (cation) is needed at half the dosage of another active ingredient (anion), then an innocuous cation could be used as filler to balance the charges. This same concept applies if more cation is needed than anion, in which case a filler anion can be used.

As described above, the fungicidal compositions can be prepared from, for example, a fungicidal anion and a bioactive cation, or from a fungicidal cation and a bioactive anion. These fungicidal compositions can display enhanced properties over the fungicides not prepared as an ionic liquid. Table 1 provides examples of fungicidal and bioactive ions suitable for forming fungicidal ionic liquids and the property enhancements of the ionic liquids.

TABLE 1

| | Anion | | | |
|---|---|---|---|---|
| | 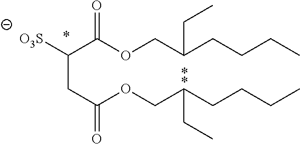 Docusate | 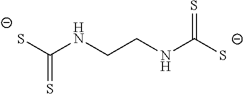 Ebdtc | 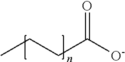 Fatty Acids (where n = 4-12) | 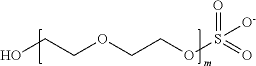 PEG sulfate |
| Cation | | | | |
| 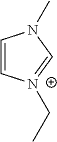 Ethylmethyl- imidazolium | Increased penetration and hydrophobicity | Evaluation of IL properties of anion | Increased penetration | Increased penetration |
| 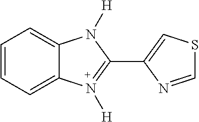 Thiabendazole | Increased penetration and hydrophobicity | Synergistic Effect and increased persistence | Increased penetration | Increased penetration |
| 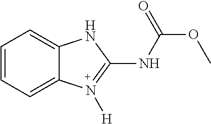 Carbendazim | Increased penetration and hydrophobicity | Synergistic Effect and increased persistence | Increased penetration | Increased penetration |
| 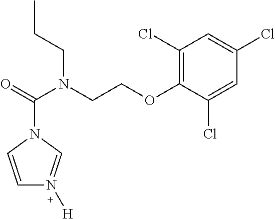 Prochloraz | Increased penetration and hydrophobicity | Synergistic Effect and increased persistence | Increased penetration | Increased penetration |
| 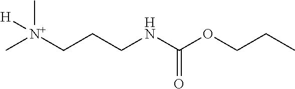 Propamocarb | Increased penetration and hydrophobicity | Synergistic Effect and increased persistence | Increased penetration | Increased penetration |
| 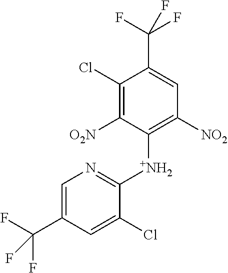 [SMILES: O=[N+]([O-])c1cc(C(F)(F)F)c(Cl)c([N+](=O)[O-])c1[NH2+]c1ncc(C(F)(F)F)cc1Cl] Fluazinam | Increased penetration and hydrophobicity | Synergistic Effect and increased persistence | Increased penetration | Increased penetration |
| 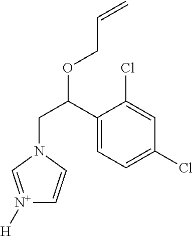 [SMILES: C=CCOC(Cn1cc[nH+]c1)c1ccc(Cl)cc1Cl] Imazalil | Increased penetration and hydrophobicity | Synergistic Effect and increased persistence | Increased penetration | Increased penetration |
| 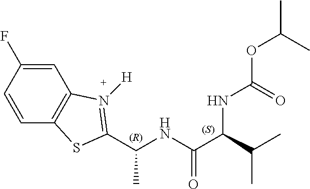 Benthiavalicarb- isopropyl | Increased penetration and hydrophobicity | Synergistic Effect and increased persistence | Increased penetration | Increased penetration |

### D. PREPARATION OF THE COMPOSITIONS

The disclosed compositions can be prepared by combining one or more kinds of cations or cation precursors with one or more kinds of anions or anion precursors. This can be done to form an ionic liquid, which can be used as it is or diluted by a solvent, or the ions or ion precursors can be mixed directly in a solution. Providing of the particular ions is largely based on the identifying desired properties of the ion (e.g., its charge and whether it has a particular bioactivity that is desired to be present in the resulting ionic liquid).

Further, when preparing a composition as disclosed herein, molecular asymmetry can be particularly desired. Low-symmetry cations and anions typically reduce packing efficiency in the crystalline state and lower melting points.

Once the desired ions are provided, the ions can be combined to form the disclosed ionic liquids. There are generally two methods for preparing an ionic liquid: (1) metathesis of a salt of the desired cation (e.g., a halide salt) with a salt of the desired anion (e.g., transition metal, like Ag, salt, Group I or II metal salt, or ammonium salt). Such reactions can be performed with many different types of salts; and (2) an acid-base neutralization reaction. Another method for forming the disclosed ionic liquid compositions involves a reaction between a salt of a desired cation, say Cation X where X is an appropriate balancing anion (including, but not necessarily, a halide), and an acid to yield the ionic liquid and HX byproduct. Conversely, the disclosed ionic liquid compositions can be formed by reacting a salt of a desired anion, say Y Anion where Y is an appropriate balancing cation, with a base to yield the ionic liquid and Y base byproduct.

For example, an anionic precursor can be treated with sodium or potassium hydroxide used in a molar ratio of from 0.7-3 to from 0.8-5, in an aqueous environment at a temperature from 273 to 373K, e.g., 325K. The product, in the form of the sodium or potassium salt of the anion can then undergo a reaction with the halide salt of a cation as described herein in the molar ratio of 1:0.7 to 1:1.5. Often during the reaction, the product can precipitate as a separate phase (lower or upper layer). In the case of phase separation, the aqueous layer can be removed and the residue, which is the product, can be washed with water several times and dried. However, if there is no phase separation, organic solvent can be used for the extraction of product from water, preferably chloroform or ethyl acetate. After extraction and combining of the organic phase, the solvent can be evaporated under reduced pressure and after drying a finished product is obtained. However, if the product is not soluble in organic solvent but soluble in water, the water can be completely evaporated, and the organic solvent (preferably acetone or ethanol) can be used to dissolve the reaction product. During this process reaction byproducts, preferably inorganic salts, can precipitate. After filtration of byproducts, the solvent can be evaporated under vacuum and the salt of the cations described herein and the anions can be obtained after drying.

Alternatively, the salts of the cations described herein and anions can be prepared by alternative procedure. A solution (preferably an aqueous or alcohol solution) of halide salts (e.g., chlorides, bromides or iodides) of the cations described herein can undergo anion exchange reactions with anion exchange resin (preferably on anion exchange column), to produce the cations with anions OH⁻. Afterwards, neutral acids (either neat or in solution can be added to form hydroxides of the cations described herein (either neat or in solution), in a molar ratio from 1:0.7 to 1:1.5 at temperatures from 0 to 100° C. After reaction, the excess of reactants can be filtered and the water can be evaporated under reduced pressure and after drying new salts of the cations and the anions described herein can be isolated.

The salts of the cations and anions described herein can be prepared by alternative procedure. The anionic precursors, sodium or potassium hydroxide, and halide salts of the cations described herein used in a molar ratio of from 0.7 to 3:from 0.8 to 5:from 0.8 to 5 can be placed in an aquatic environment at a temperature from 273 to 373K, e.g., 325K. The reaction mixture can be stirred and heated for 1 hour to 24 hours. After cooling, the mixture can be extracted by organic solvent (preferably chloroform or ethylacetate). The organic layer can then be washed several times with distilled water. The aqueous phases can be tested for the presence of chloride ion using silver nitrate solution. Finally, the organic solvent can be removed and the product can be dried.

Many of the bioactive compounds disclosed herein are cationic or can be made cationic, the identification of which can be made by simple inspection of the chemical structure as disclosed herein. Further, many of these compounds are commercially available as their halide salts or can be converted to their halide salts by reactions with acids (e.g., HF, HCl, HBr, or HI) or by treating a halogenated compound with a nucleophile such as an amine. Further many of the anions disclosed herein are commercially available as metal salts, Group I or II metal salts, or ammonium salts. Combining such cations and anions in a solvent with optional heating can thus produce the ionic liquid compositions. For a review of the synthesis of ionic liquids see, for example, Welton, Chem Rev 1999, 99:2071-2083, which is incorporated by reference herein for at least its teachings of ionic liquid synthesis.

Ionic liquids that are immiscible with water are often conveniently prepared by the combination of aqueous solutions of two precursor salts, each of which contains one of the two requisite ions of the targeted ionic liquids. On combination, the desired salt forms a separate phase from the aqueous admixture. Such phases are readily washed free of byproduct salts with additional water, and may subsequently subjected to other procedures (e.g., as disclosed in the Examples) to separate them from non-water soluble impurities.

The purification of ionic liquids can be accomplished by techniques familiar to those skilled in the art of organic and inorganic synthesis, with the notable exception of purification by distillation of the ionic liquid. In some cases, ionic liquids can be purified by crystallization at appropriate conditions of temperature and pressure (e.g., at low temperature and pressure). Such techniques can include the use of a solvent from which the ionic liquid can be crystallized at an appropriate temperature.

### E. METHODS OF USE OF THE COMPOSITIONS

The disclosed compositions have many uses. For example, the disclosed compositions can be used to allow fine tuning and control of the rate of dissolution, solubility, and bioavailability, to allow control over physical properties, to improve homogenous dosing, and to allow easier formulations. The disclosed compositions also make having compositions with additional functionality possible.

Converting an active fungicidal compound into an ionic liquid by introducing a second ion, or by providing such a combination of ions in solution, allows for enhancement of plant penetration and thus for improvement of delivery. These compositions can increase fungicidal performance due to new penetration mechanisms into the plant tissue. For example, ions with recognized surface and transport properties can be paired with the fungicidal ions described herein resulting in intensified uptake and translocation of the active compound.

The fact that the compositions are composed of cations and anions that form or can form an ionic liquid allows the tuning of hydrophilicity and hydrophobicity (among other properties), and thus control of surface wetting. The presence of a surfactant ion in a fungicidal composition alters the surface properties of the droplet, improves spreading and retention time, and changes the diffusion coefficient of the fungicide and its mobility. Additionally, the combination of two or more active chemicals in a single entity can reduce the number of additional chemicals such as adjuvants or surfactants required per application.

The compositions described herein are designed with dual functionality where both cation and anion add to the beneficial properties of the salt. In addition, secondary biological functions are introduced into the same fungicidal compound, where the broad spectrum of penetration enhancement, antimicrobial activity, and herbicidal activity of the cations adds to the fungicidal activity. Moreover, if the fungicidal activity of the disclosed compositions is even only equivalent to the commercial products, the mass (weight %) of active ingredient can be reduced.

Converting an active fungicidal compound into a composition as disclosed herein allows at least for retaining the desired fungicidal activity, while the surface and physicochemical properties are modified. Therefore, control of solubility, reduction of volatility and drift during application and use, and improved penetration into the plant tissue can be observed.

In the long-term, these fungicidal compositions can be advantageous to the consumers both economically and environmentally. Ion pairing of ionic liquids even when dissolved (in contrast to known high melting metal salt forms) means that pairing fungicides with penetration enhancers (e.g., fatty quaternary ammoniums) results in faster plant penetration. The bioactive activity of the chosen anions or cations offers additional advantages (e.g., in plant protection). By changing the bioactive ion in the resulting salts, the hydrophobicity and hydrophilicity can be tuned. The chosen bioactive ions can decrease the water solubility of fungicides.

The compositions disclosed herein that contain ionic fungicidal actives can be used in the same way as the actives themselves.

### Administration and Delivery

Formulations for administration can include sprays, liquids, and powders. The disclosed compositions having hydrophobic ions can be particularly useful in such applications because they can adhere to the surface longer when exposed to water or other fluids than would a similar hydrophilic salt. Likewise, compositions comprising fungicidal ions and hydrophobic counterions can be expected to resist erosion from rainfall.

When one or more ions in the disclosed compositions are fungicidal actives, an effective amount of the composition can be administered to an area to control pathogens of plants (e.g., a potato plant). In some examples, the fungicidal compositions can be used to control pathogen growth on potato plants. Examples of plant pathogens that can be controlled with the use of this composition include the pathogen that causes potato late blight. Further examples of plant pathogens include fungi of the genus Fusarium, the cause of potato dry rot; the genus Phoma, the cause of gangrene; and the Oomycete Phytophthora erythroseptica, the cause of pink rot. Techniques for contacting such surfaces and areas with the disclosed compositions can include, spraying, coating, dipping, immersing, or pouring the composition into or onto the surface or area. The precise technique will depend on such factors as the type and amount of infestation or contamination, the size of the area, the amount of composition needed, preference, cost, and the like. Similarly, when one or more ions in the disclosed compositions further include a pesticidal active, an effective amount of the composition can be administered to an area to control pests. When one or more ions in the disclosed compositions include an antibacterial, an effective amount of the composition can be contacted (i.e., administered) to any surface that has bacteria.

The disclosed compositions can be dissolved in a suitable solvent or carrier as are disclosed herein. This method can enhance the delivery of one or more active ions in the composition. Further, as is disclosed herein, this method can create a synergistic effect among the various ions present. While not wishing to be bound by theory, the dissociation coefficient of various ions in an ionic liquid can be different in different solvents. Thus, ions in an ionic liquid can dissociate freely in one solvent and cluster in another. This phenomenon can be utilized to provide formulations of compounds that are difficult to deliver (e.g., decrease the water solubility of fungicides and increase the penetration into the leaf). That is, compounds can be formed into an ionic liquid, as described herein, and then dissolved in a suitable solvent to provide an easily deliverable solution. A synergistic effect can be observed upon administration to a subject, when ions cluster and act together, rather than independently.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

All chemicals unless otherwise stated were purchased from Aldrich Chemical Company (Dorset, UK) and used without further purification. NMR data were recorded at 25° C. on a Bruker (Coventry, UK) 300 DRX spectrometer and the solvent peak was used as reference. Electrospray mass spectrometry was performed on a LCT Premier from Waters using an Advion nanomate injection system (Manchester, UK). Water content was measured by Karl-Fischer-titration with a Mettler Toledo Titrator (Hiranuma Sangyo, Japan). The water content of all dried ILs was found to be below 2000 ppm.

Thermogravimetric analysis was performed on a Mettler Toledo Star^{e} TGA/DSC (Leicester, UK) under nitrogen. Samples between 5 and 10 mg were placed in open alumina pans and were heated from 25° C. to 600° C. with a heating rate of 5° C./min. Decomposition temperatures (T_{5% dec}) were reported from onset to 5 wt % mass loss Infrared spectra were recorded as neat samples from 4000-450 cm⁻¹ on a Perkin-Elmer Spectrum 65 FT-IR spectrometer fitted with a Universal ATR Sampling Accessory. Differential scanning calorimetry (DSC) was performed on a Mettler Toledo Star^{e} DSC (Leicester, UK) under nitrogen. Samples between 5 and 10 mg were heated from 25° C. to 110° C. at a heating rate of 5° C./min followed by a 5 min isotherm. A cooling rate of 5° C./min to −70° C. was followed by a 5 min isotherm at −70° C., and the cycle was repeated twice. A melting transition was observed as single-event peak in the first run. Second and third cycles proved to be identical and gave a glass transition temperature only. Transitions above ambient temperature were confirmed optically on a Stuart SMP3 melting point apparatus.

### A. Synthesis

### Example 1

### Synthesis of di(1-ethyl-3-methylimidazolium)ethylenbis-(dithiocarbamate), [C₂mim]₂ebdtc

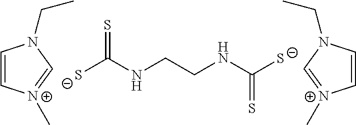

A 250 mL round bottom flask was charged with 50 mL of diethylether and 5 g (83 mmol) of freshly distilled ethylenediamine. To the mixture was then added 1-ethyl-3-methylimidazolium chloride (24.34 g, 166 mmol) to form a suspension. The suspension was stirred at room temperature and water (50 mL) was then added to completely dissolve the 1-ethyl-3-methylimidazolium chloride. Upon addition of the water, a biphasic system formed with a yellow lower phase. Sodium hydroxide (6.64 g, 166 mmol) in 10 mL water was added, followed by the dropwise addition of carbondisulfide (12.63 g, 166 mmol). The reaction temperature was maintained below 30° C. After 24 hours of stirring, the suspension turned red. The volatiles were removed by evaporation and the water traces were removed by freeze drying. The residue was dissolved in ethanol, yielding a ruby solution with a colorless crystalline precipitate. The solid was filtered and the volatile material was removed under reduced pressure to yield the product as a red sticky solid. ¹H-NMR (300 MHz, d₆-DMSO) δ (ppm)=9.6 (s, ²H), 8.4 (s, 2H1H), 7.8 (s, 2H), 7.7 (s, 2H), 4.2 (q, 4H), 3.9 (s, 6H), 3.4 (s, 4H), 1.4 (t, 6H). ¹³C-NMR (75 MHz, d₆-DMSO) δ (ppm)=167.9, 161.8, 134.5, 118.9, 71.9, 70.4, 67.7, 60.3, 55.6, 53.5. FT-IR: 3074.57, 1567.88, 1467.07, 1380.84, 1316.88, 1264.86, 1164.97, 998.15, 952.04, 864.30, 726.35, 671.73, 646.07, 616.07, 547.23, 530.15, 475.06. MS: 111 (Emim⁺), 321 (ebdtc²⁻). T_{g}−37.5, T_{5% onset} 147.1

### Example 2

### Synthesis of thiabendazolium docusate

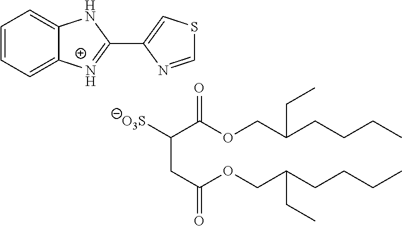

Trial A:

Thiabendazole (10.0 g, 0.05 mol) was suspended in 100 mL of water. To the suspension was then added 4.83 g of 37% HCl and an additional 150 mL of water. The resulting mixture was heated to 60° C. After cooling to 13° C., sodium docusate (21.9 g, 0.05 mol) was added and the mixture was stirred overnight. The phases were separated and the aqueous phase was extracted three times with chloroform. The solid was filtered and the volatile material was removed under reduced pressure. The residue was dried under high vacuum at 60° C. to yield 28.16 g of the product as an opaque white-off sticky solid. ¹H-NMR (300 MHz, d₆-DMSO) δ (ppm)=9.5 (s, 1H), 8.9 (s, 1H), 7.8-7.6 (m, 4H), 3.9 (m, 5H), 3.7 (s, 2H), 2.9 (m, 2H), 1.4-1.2 (m, 16H), 0.8 (t, 12H). ¹³C-NMR (75 MHz, d₆-DMSO) δ (ppm)=230.7, 229.9, 171.4, 168.7, 158.4, 144.1, 140.1, 132.2, 127.1, 126.4, 114.6, 79.5, 66.6, 66.4, 61.8, 38.5, 34.5, 30.1, 30.0, 29.9, 28.7, 23.5, 23.3, 22.7, 14.3, 11.1. FT-IR: 3089.13, 2958.35, 2929.44, 2860.67, 2762.57, 2654.29, 1733.71, 1633.57, 1596.77, 1522.24, 1464.33, 1430.94, 51.36, 1412.42, 51.45, 1390.92, 47.25, 1357.41, 50.80, 1316.31, 42.23, 1254.02, 26.41, 1213.30, 26.85, 1105.47, 59.00, 1036.73, 27.50, 981.51, 51.03, 887.27, 46.56, 854.87, 49.97, 826.29, 52.43, 754.27, 37.97, 664.99, 68.15, 635.64, 67.98, 619.24, 56.55, 571.33, 58.01, 521.39, 46.97, 489.18, 67.05.

Trial B:

Thiabendazole (10.00 g, 0.05 mol) was suspended in 50 mL of distilled water and a solution of HCl (5.03 g, 0.05 mmol, ˜37% in H₂O) was added. The suspension was stirred for 60 min at room temperature and the solvent was evaporated. The remaining white solid was dissolved in 100 mL of acetone/H₂O 1:1, sodium docusate (22.23 g, 0.05 mol) was added and stirred overnight at room temperature. Acetone was evaporated, and the remaining suspension was diluted with 100 mL of H₂O. The crude mixture was repeatedly extracted with dichloromethane (200 mL). The combined organic layers were washed successively with water until no more chloride ions could be detected in the washings (checked by addition of AgNO₃ solution), dried over MgSO₄, filtered, and the solvent was evaporated. Remaining volatile material was removed under reduced pressure (0.01 mbar, 60° C.) with stirring to gave thiabendazolium docusate 3 in 91% yield as colourless gel. ¹H NMR (300 MHz, d₆-DMSO): δ 9.51 (d, J=1.74 Hz, 1H), 8.91 (d, J=1.77 Hz, 1H), 7.83 (m, 2H), 7.56 (m, 2H), 3.85 (m, 4H), 3.72 (m, 1H), 2.89 (m, 2H), 1.40 (m, 2H), 1.19 (m, 16H), 0.80 (m, 12H). ¹³C NMR (75 MHz, d₆-DMSO): δ 230.71, 229.86, 171.09, 168.37, 158.22, 143.77, 139.71, 131.81, 127.07, 126.08, 114.20, 66.35, 66.34, 61.61, 38.07, 33.99, 29.67, 29.52, 28.27, 23.09, 22.91, 22.35, 13.81, 10.67. IR (neat) v=3088, 2957, 2929, 1731, 1633, 1464, 1315, 1153, 1034, 886, 751, 618, 519 cm⁻¹. HRMS (ESI+) calc. for C₁₀H₈N₃S 202.0433, found 202.0421, HRMS (ESI−) calc. for C₂₀H₃₇O₇S 421.2265, found 421.2260. T_{g} −16.3° C.; mp 46.9° C.; T_{5% onset} 252.0° C.

### Example 3

### Synthesis of thiabendazolium stearate

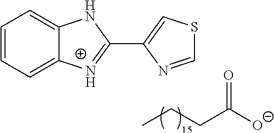

Thiabendazole (10.0 g, 0.05 mol) and stearic acid (14.14 g, 0.05 mol) were suspended in chloroform (20 mL). The resulting mixture was sonicated for 15 min, and then heated to 60° C. for 5 hours. After cooling, the mixture turned into a white solid. ¹H-NMR (300 MHz, d₆-DMSO) δ(ppm)=12.9 (s, 1H), 11.9 (s, 1H), 9.3 (s, 1H), 8.4 (s, 1H), 7.2-8.3 (m, 4H), 2.5 (t, 2H), 2.2 (m, 2H), 1.5 (m, 28H), 0.8 (t, 3H). ¹³C-NMR (75 MHz, d₆-DMSO) δ (ppm)=231, 174.8, 155.8, 147.5, 147.3, 144.1, 141.5, 122.9, 122.1, 119.7, 119.1, 112.1, 40.4, 40.1, 39.9, 39.6, 39.3, 39.1, 29.4, 29.1, 28.9, 22.5, 14.3. MS: 202 (C⁺+H), 283 (A⁻).

### Example 4

### Synthesis of imazalilium docusate

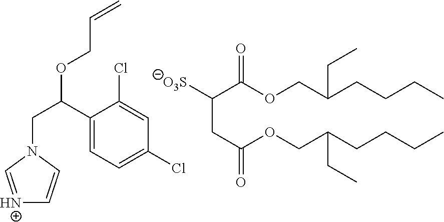

Trial A:

Imazalil sulfate (2.82 g, 8.14 mmol) was suspended in 20 mL chloroform. To this solution was added sodium docusate (3.59 g, 8.14 mmol) in 20 mL chloroform, and the resulting mixture was heated to 65° C. A white precipitate of Na₂SO₄ was observed. The mixture turned opaque at 70° C. The mixture was cooled down to room temperature and dried over MgSO₄. After filtration, the volatiles were removed under reduced pressure, and the residue was dried under high vacuum at 70° C. to yield 5.65 g of product as a yellow and very sticky solid which crystallized with cooling. ¹H-NMR (300 MHz, d₆-DMSO) δ (ppm)=14.3, 9.1 (s, 1H), 7.8-7.2 (m, 5H), 5.8 (m, 1H), 5.1 (m, 3H), 4.5 (m, 2H), 3.7 (m, 6H), 3.6 (m, 2H), 2.9 (m, 2H), 2.1 (s, 3H), 1.5 (m, 2H), 1.2 (m, 16H), 0.9 (t, 12H). ¹³C-NMR (75 MHz, d₆-DMSO) δ (ppm)=230.7, 229.9, 171.4, 168.7, 134.3, 133.5, 129.7, 129.5, 128.4, 123.3, 120, 117.5, 75, 66.5, 61.8, 52.1, 39, 34.5, 30, 28.7, 22.7, 14.2, 11.1.

Trial B:

Imazalil sulfate (3.2178 g, 8.141 mmol), suspended in 20 mL chloroform and 3.594 g (8.141 mmol) sodium docusate, dissolved in 20 mL chloroform, were combined in a 50 mL round bottom flask and refluxed for 1 h. The resulting suspension was cooled to 0° C. and filtered over a batch of silica. The combined organic layers were washed once with H₂O (care must be taken in this step to avoid emulsion formation), dried over MgSO₄, filtered, and the solvent was evaporated. Any remaining volatile material was removed under reduced pressure (0.01 mbar, 60° C.) with stirring to give imazalilium docusate in 61% yield as yellow viscous liquid. ¹H NMR (300 MHz, d₆-DMSO): δ 14.32 (br s, 1H), 8.97 (s, 1H), 7.71 (d, J=2.10 Hz, 2H), 7.63 (dt, J₁=12.61 Hz, J₂=1.58 Hz, 1H), 7.51 (dd, J₁=8.40 Hz, J₂=2.27 Hz, 1H), 7.32 (d, J=8.58 Hz, 1H), 5.74 (m, 1H), 5.11 (m, 3H), 4.50 (m, 2H), 3.88 (m, 6H), 3.64 (m, 1H), 2.86 (m, 2H), 1.49 (m, 2H), 1.26 (m, 16H), 0.83 (m, 12H). ¹³C-NMR (75 MHz, d₆-DMSO): 8171.06, 168.37, 136.27, 133.99, 133.93, 133.15, 129.30, 129.20, 128.03, 122.83, 120.19, 117.16, 69.48, 66.08, 66.06, 61.43, 51.71, 38.15, 34.13, 29.63, 29.53, 28.33, 23.19, 23.35, 22.98, 22.44, 13.96, 11.80. IR (neat) v=2958, 2929, 2859, 1720, 1586, 1458, 1253, 1199, 1168, 1034, 853, 788, 643, 538 cm⁻¹. HRMS (ESI+) calc. for C₁₄H₁₅Cl₂N₂O 297.0556, found 297.0561, HRMS (ESI−) calc. for C₂₀H₃₇O₂S 421.2265, found 421.2260. T_{g}−28.0° C.; mp 70.0° C.; T_{5% onset} 208.8° C.

### B. Biological Testing

### Example 5

### Sensitivity Testing of Fungi to Thiabendazole (TBZ) Derivatives (TBZ Docusate Prepared According to Trial a and TBZ Stearate)

### Stock Preparation:

Both TBZ docusate and TBZ stearate were tested at final concentrations of 250 μm and 25 μm in agar. To prepare the TBZ docusate stock solution for 250 μm, 0.155 g of TBZ docusate prepared according to Trial A was added to a 10 mL volumetric flask and was dissolved in 10 mL of ethanol. The solution was mixed thoroughly. To prepare the TBZ docusate stock solution for 25 μm, 1 ml of the above stock solution was pipetted into a second 10 mL flask and 10 mL ethanol was added. The solution was mixed thoroughly. To prepare the TBZ stearate stock solution for 250 μm, 0.121 g of TBZ stearate was added to a 10 mL volumetric flask and was dissolved in 10 mL ethanol. The solution was mixed thoroughly. To prepare the TBZ stearate stock solution for 25 μm, 1 mL of the 250 μm TBZ stearate stock solution was pipetted into a second 10 mL flask and 10 mL ethanol was added. The solution was mixed thoroughly.

### General Agar Preparation:

The agar was prepared and autoclaved. Potato dextrose agar (PDA) was used for the Fusarium species and Phytophthora erythroseptica and malt agar was used for the Phoma species. The agar was allowed to cool to 50° C. Each of the stock solutions was added to the agar at the rate of 10 mL stock solution per liter of agar to give the two final concentrations, for both TBZ stearate and docusate, in agar. Also prepared were a 1% ethanol control (10 mL per liter of agar) and an untreated agar as a second control. The plates were prepared in triplicate for each concentration.

For each pathogen isolate tested, 3 plates of 250 μm/1, 3 plates of 25 μm/1, 3 plates of 1% ethanol, and 3 plates of untreated agar were inoculated using an agar plug cut with a no. 3 cork borer from the margin of an actively-growing culture on agar. The plates were incubated at an appropriate temperature (usually 18-20° C.) in darkness. The growth rate was monitored and assessed after 5-7 days. The growth was assessed by measuring colony diameters minus plug (two measurements at right-angles) per plate. The percent reduction was calculated with respect to the control.

### Thiabendazole Sensitivity Testing:

Pure thiabendazole (TBZ; 0.5 g) obtained from MSD Agvet (Rahway, N.J.) was dissolved in water (10 mL) by adding the minimum required volume (c. 0.5 mL) of hypophosphorous acid and heating gently with stirring, then made up to 100 mL with water to give a stock solution (25 mM). TBZ docusate (0.155 g) or TBZ stearate (0.121 g) was dissolved in ethanol (100 ml) to give stock solutions (25 mM). A ten-fold dilution of each of these stock solutions was prepared (in water for TBZ and in ethanol for TBZ docusate and stearate). Each solution was added to separate aliquots of either potato dextrose agar (PDA) or malt agar (MA), depending on the species to be tested, at the rate of 10 mL per litre and mixed thoroughly to give final concentrations of 250 and 25 μM of each compound in agar. In addition, agar with 1% v/v ethanol and unamended agar was prepared (ethanol and unamended controls). The agar was poured into Petri plates (9 cm) and allowed to set.

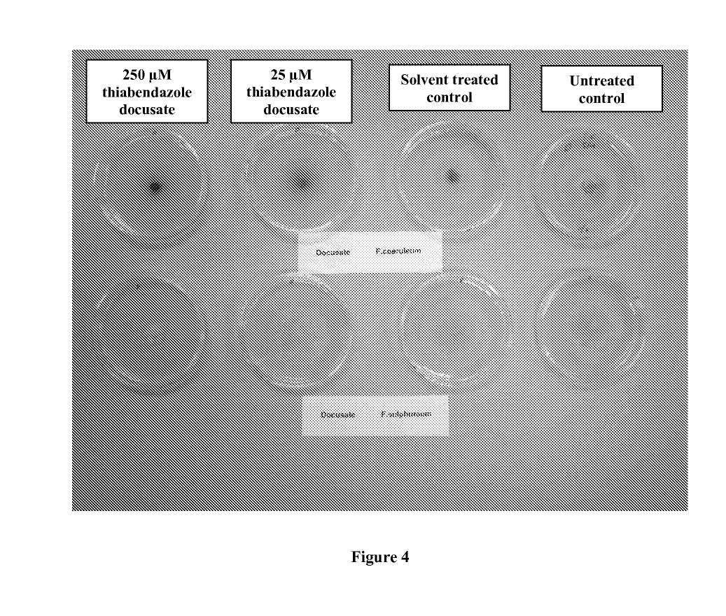

Isolates of the appropriate potato tuber pathogens were grown on PDA for Fusarium spp. and Phytophthora erythroseptica or on MA for Phoma spp. Each isolate to be tested was inoculated onto three replicate plates of the two concentrations of each compound and onto ethanol and unamended agar controls using plugs (6 mm diameter) cut from the margins of actively growing cultures. Plates were incubated in darkness at 20° C. and mycelial growth measured (two measurements at right-angles for each plate) after 5-7 days (depending on the growth rates). The percentage reduction in growth in the presence of the test compounds was calculated with respect to the appropriate control (See Table 2 and FIGS. 3-5).

TABLE 2

| | | Inhibition (%) | | |
|---|---|---|---|---|
| | Concentration | | TBZ | TBZ |
| Isolate | (μM) | TBZ | docusate | stearate |
| F. sulphureum ex SASA | 250 | 87 | 97 | 90 |
| | 25 | 17 | 27 | 25 |
| F. coeruleum ex B7/06 T8 | 250 | 98 | 98 | 98 |
| | 25 | 99 | 98 | 98 |
| F. culmorum P13 | 250 | 100 | 100 | 100 |
| | 25 | 100 | 100 | 100 |
| P. foveata BL2 05 T3 | 250 | 100 | 99 | 99 |
| | 25 | 98 | 95 | 96 |
| P. exigua 9.1 | 250 | 100 | 98 | 98 |
| | 25 | 92 | 90 | 93 |
| P. erythroseptica | 250 | 76 | 100 | 69 |
| BL2/08 P31 | 25 | 9 | 62 | 2 |

These tests indicated that both TBZ derivatives retained their activity against Fusarium spp., but that activity against the TBZ-resistant F. sulphureum had probably not been enhanced.

### Example 6

### Sensitivity Testing of Fungi to Imazalilium Docusate Prepared According to Trial A

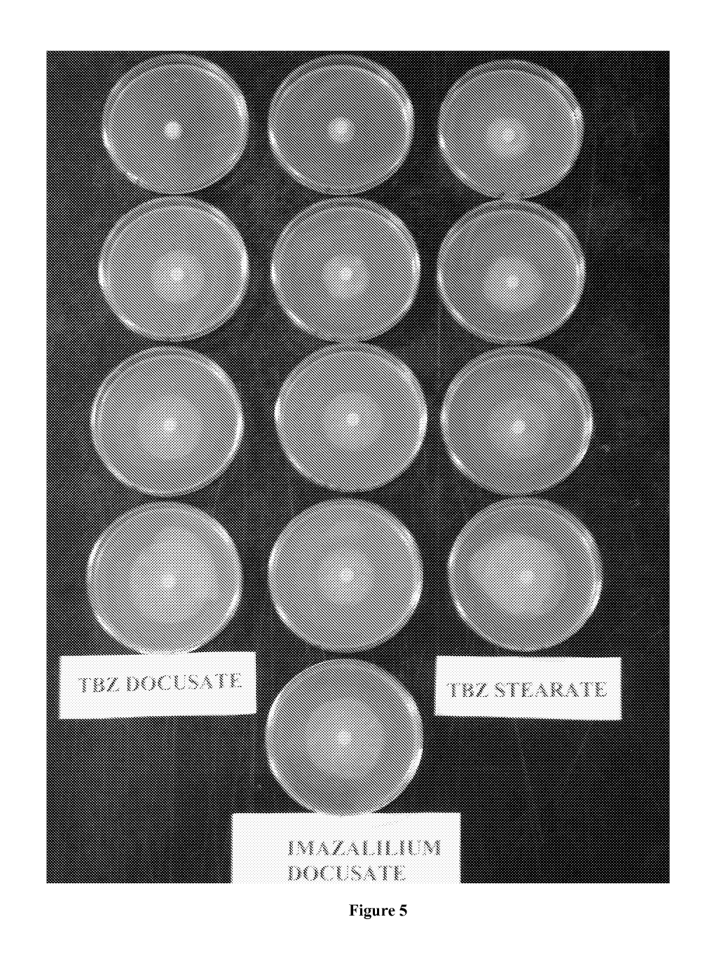

Imazalilium docusate was tested (at concentrations equivalent to 0.5, 1, 5, 10, and 50 mg imazalil/L) against the same fungal isolates and approximate ED₅₀ values were determined (see Table 3 and FIG. 5).

TABLE 3

| Isolate | ED₅₀ mg/L |
|---|---|
| F. sulphureum L'gall 53 | 0.5 |
| F. sulphureum L'gall 10 | 0.5 |
| F. sulphureum L'gall 11 | 0.6 |
| F. coeruleum ex B7/06 T8 | <0.5 |
| F. coeruleum ex B16/08 P31 | <0.5 |
| P. erythroseptica BL2/08 P31 | 26 |
| P. erythroseptica Rooster Eire | 22 |

These values are similar to those obtained with imazalil sulphate in previous tests. F. sulphureum has ED₅₀ values 1-3 mg/l, F. coeruleum 2-9 mg/l. These tests demonstrate that the imazalilium docusate has retained its fungitoxicity, and that it may even be enhanced.

### Example 7

### Sensitivity Testing of Potato Tuber Pathogens to Derivatives of Thiabendazole

In vitro tests of the IL thiabendazolium docusate were performed in comparison to the neutral fungicide using selected isolates of Fusarium spp., the cause of potato dry rot. F. coeruleum and F. culmorum are sensitive to thiabendazole whereas isolates of F. sambucinum are frequently resistant. Isolates of Phoma spp., the cause of gangrene, and Phytophthora erythroseptica, the cause of pink rot, were also tested. All isolates were obtained from naturally infected potato tubers as indicated in Table 4. All except F. sambucinum ex SASA were isolated in a laboratory. F. sambucinum ex SASA was supplied by SASA (Science and Advice for Scottish Agriculture, Roddinglaw Road, Edinburgh, EH12 9F, UK).

TABLE 4

| Isolate | Origin (year of isolation) |
|---|---|
| F. sambucinum ex SASA | SASA, Scotland (2004) |
| F. sambucinum L'gall 10 | AFBI, Northern Ireland (2009) |
| F. sambucinum L'gall 11 | AFBI, Northern Ireland (2009) |
| F. sambucinum L'gall 53 | AFBI, Northern Ireland (2009) |
| F. coeruleum ex B7/06 T8 | AFBI, Northern Ireland (2006) |
| F. coeruleum ex B16/08 P31 | AFBI, Northern Ireland (2008) |
| F. culmorum P13 | AFBI, Northern Ireland (pre-2000) |
| Phoma exigua 9.1 | AFBI, Northern Ireland (1999) |
| Phoma foveata BL2 05 T3 | AFBI, Northern Ireland (2005) |
| P. erythroseptica BL2/08 P31 | AFBI, Northern Ireland (2008) |
| P. erythroseptica Rooster Eire | AFBI, tubers from Republic of Ireland |
| | (2008) |

In each test three replicate plates for each organism per concentration were used and tests were repeated at least once.

For tests with thiabendazole (TBZ), TBZ docusate prepared according to Trial B, and TBZ stearate, TBZ (0.5 g, drug pure, MSD Agvet) was dissolved in water (10 ml) by adding the minimum required volume (c. 0.5 ml) of hypophosphorous acid and heating gently with stirring, then made up to 100 ml with water to give a stock solution (25 mM). TBZ docusate (0.155 g) or TBZ stearate (0.121 g) were dissolved in ethanol (100 ml) to give stock solutions (25 mM). A ten-fold dilution of each of these stock solutions was prepared (in water for TBZ and in ethanol for TBZ docusate and stearate). Each solution was added to separate aliquots of either potato dextrose agar (PDA) or malt agar (MA), depending on the species to be tested, at the rate of 10 ml per litre and mixed thoroughly to give final concentrations of 250 and 25 μM of each compound in agar. In addition, agar with 1% v/v ethanol and unamended agar was prepared (ethanol and unamended controls). The agar was poured into Petri plates (9 cm) and allowed to set.

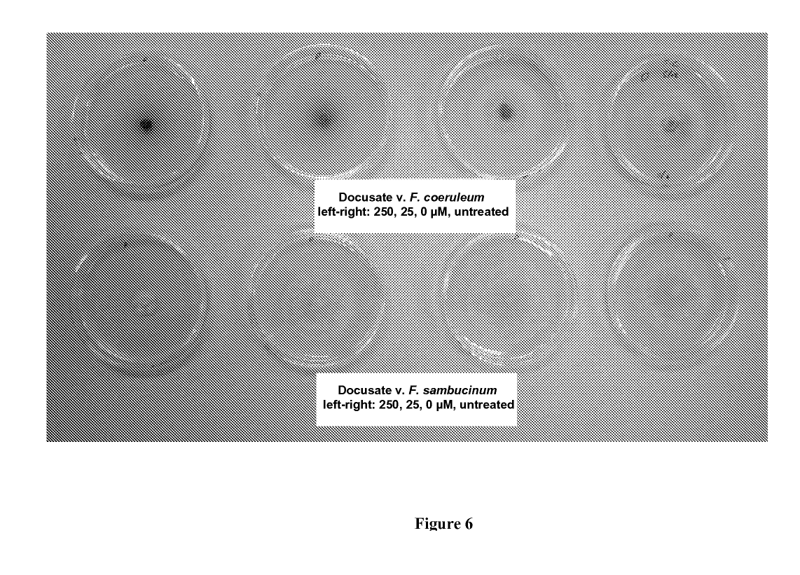

Isolates of the appropriate potato tuber pathogens were grown on PDA for Fusarium spp. and Phytophthora erythroseptica or on MA for Phoma spp. Each isolate to be tested was inoculated onto three replicate plates of the two concentrations of each compound and onto ethanol and unamended agar controls using plugs (6 mm diameter) cut from the margins of actively growing cultures. Plates were incubated in darkness at 20° C. and mycelial growth measured (two measurements at right-angles for each plate) after 5-7 days (depending on the growth rates). The percentage reduction in growth in the presence of the test compounds was calculated with respect to a 1% ethanol control (see Table 5 and FIG. 6).

TABLE 5

| | | Inhibition (%) | | |
|---|---|---|---|---|
| | Concentration | | TBZ | TBZ-stearic |
| Isolate | (μM) | TBZ | docusate | acid |
| F. sambucinum ex SASA | 250 | 89 | 96 | 89 |
| | 25 | 22 | 19 | 24 |
| F. sambucinum L'gall 53 | 250 | 93 | 68 | 82 |
| | 25 | 19 | 11 | 20 |
| F. sambucinum L'gall 11 | 250 | 76 | 83 | 82 |
| | 25 | 8 | 19 | 10 |
| F. coeruleum ex B7/06 T8 | 250 | 99 | 99 | 99 |
| | 25 | 99 | 99 | 99 |
| F. coeruleum ex B16/08 P31 | 250 | 100 | 100 | 100 |
| | 25 | 100 | 100 | 100 |
| F. culmorum P13 | 250 | 100 | 100 | 100 |
| | 25 | 100 | 100 | 100 |
| Phoma exigua 9.1 | 250 | 100 | 99 | 99 |
| | 25 | 95 | 94 | 95 |
| Phoma foveata BL2 05 T3 | 250 | 100 | 99 | 99 |
| | 25 | 98 | 95 | 97 |
| Phytophthora erythroseptica | 250 | 51 | 97 | 54 |
| BL2/08 P31 | 25 | 4 | 33 | 10 |
| Phytophthora erythroseptica | 250 | 31 | 91 | 34 |
| Rooster Eire | 25 | 8 | 11 | 11 |

The activity of thiabendazole (TBZ) against the Fusarium and Phoma spp. was retained for the hydrophobic IL formulation (see FIG. 6, Table 5). Furthermore, while thiabendazole is not considered active against the Oomycete pathogen, P. erythroseptica, there is some evidence that the IL thiabendazole docusate is more active. A co-formulation of the neutral active thiabendazole with stearic acid, a second hydrophobic molecule that did not lead to protonation and IL formation (see K. Bica, J. Shamshina, W. Hough, D. MacFarlane and R. D. Rogers, Chem. Commun., 2011, 47, 2267-2269), did not enhance the activity, as was observed for thiabendazole docusate, but gave values similar to those of thiabendazole alone. Not to be bound by theory, this behavior can be explained by the tendency of hydrophobic ILs to form ion pairs in solution, which makes them inherently different from a simple co-formulation of the active compounds with a second hydrophobic neutral (see K. J. Fraser, E. I. Izgorodina, M. Forsyth, J. L. Scott and D. R. MacFarlane, Chem. Commun., 2007, 37, 3817-3819; D. F. Kennedy and C. J. Drummond, J. Phys. Chem., 2009, 113, 5690-5693).

### Example 8

### Sensitivity Testing of Potato Tuber Pathogens to Derivatives of Imazalil

For tests with imazalil sulphate and imazalilium docusate prepared according to Trial B, imazalil sulphate (0.5 g, drug pure, Janssen) was dissolved in sterile water (100 ml) to give a stock solution (12.7 mM). Imazalilium docusate (0.91 g) was dissolved in ethanol (100 ml) to give a stock solution (12.7 mM). Dilutions (alternately five-fold and two-fold) of each of these stock solutions were prepared (in water for imazalil sulphate and in ethanol for imazalilium docusate) to produce a dilution series (12.7, 2.54, 1.27, 0.25, and 0.13 mM). Each solution was added to separate aliquots of either potato dextrose agar (PDA) or malt agar (MA), depending on the species to be tested, at the rate of 10 ml per litre and mixed thoroughly to give final concentrations of at 127, 25, 12.7, 2.5 and 1.27 μM of each compound in agar (equivalent to 0.5, 1, 5, 10 and 50 mg imazalil per liter). In addition, agar with 1% v/v ethanol and unamended agar was prepared (ethanol and unamended controls). The agar was poured into Petri plates (9 cm) and allowed to set.

Isolates of the appropriate potato tuber pathogens were grown on PDA for Fusarium spp. and Phytophthora erythroseptica or on MA for Phoma spp. Each isolate to be tested was inoculated onto three replicate plates of the two concentrations of each compound and onto ethanol and unamended agar controls using plugs (6 mm diameter) cut from the margins of actively growing cultures. Plates were incubated in darkness at 20° C. and mycelial growth measured (two measurements at right-angles for each plate) after 5-7 days (depending on the growth rates). The percentage reduction in growth in the presence of the test compounds was calculated with respect to the appropriate control. Log-probability plots of the percentage reduction in growth against the concentration were used to estimate EC₅₀ values (the concentration required to reduce mycelial growth by 50%) (see Table 6).

TABLE 6

| | EC₅₀ (μM) | |
|---|---|---|
| Isolate | Imazalil | Imazalilium docusate |
| F. sambucinum ex SASA | 0.7 | 1.0 |
| F. sambucinum L'gall 11 | 1.8 | 2.6 |
| F. coeruleum ex B7/06 T8 | 12.9 | 19.2 |
| F. culmorum P13 | 0.4 | 0.4 |
| Phoma exigua 9.1 | 5.6 | 7.3 |
| Phoma foveata BL2/5 T3 | 2.7 | 4.6 |
| P. erythroseptica BL2/08 P31 | >127 | 38.4 |
| P. erythroseptica Rooster Eire | >127 | 100.4 |

The activity was retained with EC₅₀ values similar to those obtained with neutral imazalil (see Table 6). Imazalil, an inhibitor of fungal ergosterol synthesis, is not active against Oomycete pathogens, but the hydrophobic IL imazalilium docusate showed some activity against P. erythroseptica.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1. A composition, comprising: at least one kind of cation and at least one kind of anion, wherein the cation or the anion is a fungicide and the other of the cation or anion has a bioactive property.

2. The composition of claim 1, wherein the cation is a fungicide and the anion has the bioactive property selected from the group consisting of an herbicidal active, a pesticidal active, a nutritional active, an algaecidal active, an insecticidal active, a miticidal active, a molluscicidal active, a nematicidal active, a rodenticidal active, and a virucidal active.

3. The composition of claim 1, wherein the anion is a fungicide and the cation has the bioactive property selected from the group consisting of an herbicidal active, a pesticidal active, a nutritional active, an algaecidal active, an insecticidal active, a miticidal active, a molluscicidal active, a nematicidal active, a rodenticidal active, and a virucidal active

4. The composition of claim 1, wherein the fungicide is a demethylation inhibitor.

5. The composition of claim 1, wherein the cation or anion having the bioactive property is a surfactant or a penetration enhancer.

6. The composition of claim 5, wherein the penetration enhancer is docusate, a C₁₀-C₂₆ fatty acid anion, or an anionic PEG compound.

7. The composition of claim 1, wherein the cation is selected from the group consisting of a thiabendazole cation, an imazalil cation, an imidazolium cation, and a prochloraz cation.

8. The composition of claim 1, wherein the imidazolium cation is a benzimidazolium cation.

9. The composition of claim 1, wherein the anion is selected from the group consisting of docusate, stearate, a dithiocarbamate anion.

10. The composition of claim 1, wherein the cation selected from the group consisting of ethylmethyl-imidazolium, thiabendazole, carbendazim, prochloraz, propamocarb, fluazinam, imazalil, and benthiavalicarb-isopropyl; and wherein the anion is selected from the group consisting of docusate, ebdtc, C₁₀-C₂₆ fatty acid, and PEG sulfate.

11. The composition of claim 1, wherein the cation is thiabendazole and the anion is docusate.

12. The composition of claim 1, wherein the cation is thiabendazole and the anion is stearate.

13. The composition of claim 1, wherein the cation is imazalil and the anion is docusate.

14. The composition of claim 1, wherein the cation is 1-ethyl-3-methylimidazolium and anion is ethylenbis(dithiocarbamate).

15. (canceled)

16. (canceled)

17. (canceled)

18. The composition of claim 1, wherein the composition is an ionic liquid and is liquid at a temperature at or below about 25° C.

19. (canceled)

20. The composition of claim 1, wherein the composition is an ionic liquid and is liquid at a temperature from about 0° C. to about 120° C.

21. The composition of claim 1, wherein the composition is an ionic liquid and is liquid at a temperature of about 37° C.

22. (canceled)

23. A method of preventing or inhibiting fungal growth on a plant, comprising administering an effective amount of the composition of claim 1 to the plant.

24. The method of claim 23, wherein the plant is a potato plant.

25. The method of claim 23, wherein the fungus comprises a late potato blight fungus.

26. The method of claim 23, wherein the fungus comprises a Fusarium fungus.

27. The method of claim 23, wherein the pathogen comprises a Phytophthora species.

28. The method of claim 27, wherein the Phytophthora species is Phytophthora erythroseptica.

29. A method of preparing a composition, comprising:
combining at least one kind of cation or its precursor and at least one kind of anion or its precursor, wherein at least one of the cation or its precursor or the anion or its precursor is a fungicide and the other has a bioactive property.

30. The method of claim 29, further comprising diluting the composition with a solvent.

31. The method of claim 29, wherein combining the cation and the anion is accomplished by a metathesis reaction.

32. The method of claim 29, wherein combining the cation precursor and the anion precursor is accomplished by an acid-based neutralization reaction.
